(19) United States
(12) Patent Application Publication
(10) Pub. No.: US 2026/0082403 A1
(43) Pub. Date: Mar. 19, 2026

(54) WIRELESS COMMUNICATION METHOD AND WIRELESS COMMUNICATION DEVICE

(71) Applicant: GUANGDONG OPPO MOBILE TELECOMMUNICATIONS CORP., LTD., Dongguan (CN)

(72) Inventor: Nande ZHAO, Dongguan (CN)

(21) Appl. No.: 19/399,443

(22) Filed: Nov. 24, 2025

Related U.S. Application Data
(63) Continuation of application No. PCT/CN2023/111557, filed on Aug. 7, 2023.

(51) Int. Cl. H04W 72/27; H04B 17/318; H04W 72/044; H04W 74/0833

(52) U.S. Cl. CPC H04W 72/27; H04B 17/318; H04W 72/044; H04W 74/0833

(57) ABSTRACT

A wireless communication method and a wireless communication device are provided. The method includes an operation that a terminal device receives at least one first channel transmitted by a first access device set. The first access device set includes at least one access device, the at least one first channel transmitted by the first access device set is used for determining whether the first access device set is a target access device set, and the target access device set is used for performing data communication with the terminal device.

### CROSS-REFERENCE TO RELATED APPLICATION

This is a continuation application of International Patent Application No. PCT/CN2023/111557, filed on August 7, 2023, the disclosure of which is hereby incorporated by reference in its entirety.

### BACKGROUND

A cell-free radio access network refers to a network composed of a large number of distributed low-cost and low-power wireless access points (APs). The APs can implement simple physical layer functions such as transmission and reception of wireless signals, channel estimation, downlink precoding and uplink signal detection. In addition, different APs are connected to one or more central control devices through backhaul links, and the central control devices can implement complex physical layer functions such as data distribution and merging of APs, signal modulation and demodulation, information bit coding and decoding, so that all APs can jointly provide services for each terminal at the same time. However, when all APs jointly provide services for the terminal at the same time, there are problems such as high signaling overhead and high computational complexity.

### SUMMARY

The embodiments of the present disclosure relate to the technical field of mobile communication, in particular to a wireless communication method, a wireless communication device.

A wireless communication method according to an embodiment of the present disclosure includes an operation as follows.

A terminal device receives at least one first channel transmitted by a first access device set. The first access device set includes at least one access device, the at least one first channel transmitted by the first access device set is used for determining whether the first access device set is a target access device set, and the target access device set is used for performing data communication with the terminal device.

A wireless communication method according to an embodiment of the present disclosure includes an operation as follows.

A first access device transmits a first channel to a terminal device. The first access device belongs to a first access device set, the first access device set includes at least one access device, at least one of first channels transmitted by the first access device set is used for determining whether the first access device set is a target access device set, and the target access device set is used for performing data communication with the terminal device.

The communication device provided by the embodiment of the present disclosure may be the terminal device in the above solution or the first access point in the above solution, and the communication device includes a processor and a memory. The memory is configured to store a computer program, and the processor is configured to call and run the computer program stored in the memory to perform the wireless communication method described above.

### BRIEF DESCRIPTION OF THE DRAWINGS

The accompanying drawings described herein are intended to provide a further understanding for the present disclosure, and constitute a part of the present disclosure, and the schematic embodiments of the present disclosure and the description thereof are intended to explain the present disclosure, and do not constitute an undue limitation of the present disclosure. In the drawings:

FIG. 1 is a schematic diagram of an application scenario according to an embodiment of the present disclosure.

FIG. 2 is a schematic architecture diagram of a communication system provided by an embodiment of the present disclosure.

FIG. 3 is a schematic architecture diagram of another communication system provided by an embodiment of the present disclosure.

FIG. 4 is a schematic diagram of a non-terrestrial network (NTN) scenario based on a transparent payload satellite according to an embodiment of the present disclosure.

FIG. 5 is a schematic diagram of an NTN scenario based on a regenerative payload satellite according to an embodiment of the present disclosure.

FIG. 6 is an optional schematic structural diagram of a cell-free radio access network according to an embodiment of the present disclosure.

FIG. 7 is an optional schematic flow diagram of a wireless communication method according to an embodiment of the present disclosure.

FIG. 8 is an optional schematic flow diagram of a wireless communication method according to an embodiment of the present disclosure.

FIG. 9 is an optional schematic flow diagram of a wireless communication method according to an embodiment of the present disclosure.

FIG. 10 is an optional schematic flow diagram of a wireless communication method according to an embodiment of the present disclosure.

FIG. 11 is a schematic diagram of an optional interaction flow of a first channel according to an embodiment of the present disclosure.

FIG. 12 is an optional schematic diagram of a position of a third channel according to the embodiment of the present disclosure;

FIG. 13 is an optional schematic flow diagram of a wireless communication method according to an embodiment of the present disclosure.

FIG. 14 is an optional schematic diagram of the position of a fourth channel according to the embodiment of the present disclosure;

FIG. 15 is an optional schematic structural diagram of a candidate AP set according to an embodiment of the present disclosure.

FIG. 16 is an optional schematic structural diagram of a terminal device according to an embodiment of the present disclosure.

FIG. 17 is an optional schematic structural diagram of a first AP according to an embodiment of the present disclosure.

FIG. 18 is a schematic structural diagram of a communication device according to an embodiment of the present disclosure.

FIG. 19 is a schematic structural diagram of a chip according to an embodiment of the present disclosure.

FIG. 20 is a schematic block diagram of a communication system according to an embodiment of the present disclosure.

### DETAILED DESCRIPTION

Hereinafter, the technical solutions in the embodiments of the present disclosure will be described with reference to the accompanying drawings in the embodiments of the present disclosure, and it is apparent that the described embodiments are a part rather than all of the embodiments of the present disclosure. Based on the embodiments in the present disclosure, all other embodiments obtained by those skilled in the art without creative work fall within the scope of protection of the present disclosure.

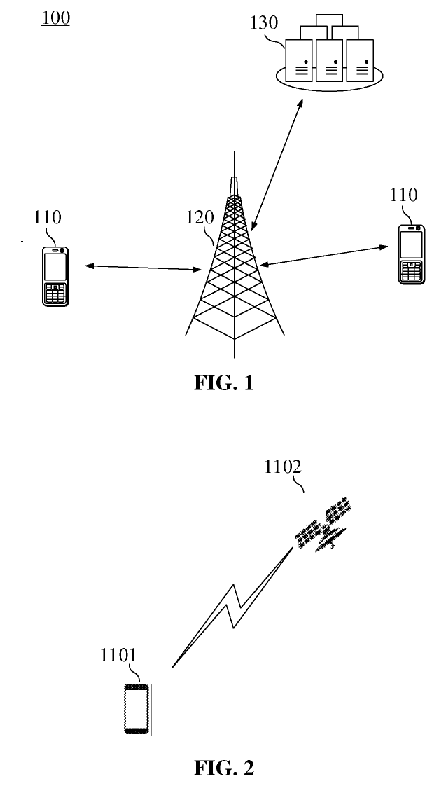

FIG. 1 is a schematic diagram of an application scenario according to an embodiment of the present disclosure.

As shown in FIG. 1, the communication system 100 may include a terminal device 110 and a network device 120. The network device 120 may communicate with the terminal device 110 through an air interface. Multi-service transmission is supported between the terminal device 110 and the network device 120.

It should be understood that the embodiments of the present disclosure are only illustrated with reference to the communication system 100, but the embodiments of the present disclosure are not limited thereto. That is, the technical solution of the embodiment of the present disclosure can be applied to various communication systems, such as a Long Term Evolution (LTE) system, an LTE Time Division Duplex (TDD), a Universal Mobile Telecommunication System (UMTS), an Internet of Things (IoT) system, and a Narrow Band Internet of Things (NB-IoT). System, an enhanced Machine-Type Communications (eMTC) system, a 5th generation (5G) communication system (also referred to as a New Radio (NR) communication system), or a future communication system, etc.

In the communication system 100 illustrated in FIG. 1, the network device 120 may be an access network device that communicates with the terminal device 110. An access network device may provide communication coverage for a particular geographic area and may communicate with a terminal device 110, such as a User Equipment (UE), located within the coverage area.

The network device 120 may be an Evolutionary Node B (eNB, or eNodeB) in a Long Term Evolution (LTE) system, a Next Generation Radio Access Network (NG RAN) device, a base station (gNB) in an NR system, or a radio controller in a Cloud Radio Access Network (CRAN). Alternatively, the network device 120 may be a relay station, an access point, an in-vehicle device, a wearable device, a hub, a switch, a bridge, a router, or a network device in a future evolved Public Land Mobile Network (PLMN).

The terminal device 110 may be any terminal device including, but not limited to, a terminal device connected with the network device 120 or other terminal device using a wired or wireless connection.

For example, the terminal device 110 may refer to an access terminal, a UE, a subscriber unit, a subscriber station, a mobile station, a mobile unit, a remote station, a remote terminal, a mobile device, a user terminal, a terminal, a wireless communication device, a user agent, or a user device. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device having wireless communication functionality, a computing device or other processing device connected to a wireless modem, a vehicle-mounted device, a wearable device, a terminal device in the 5G network or a terminal device in a future evolution network, or the like.

The terminal device 110 may be used for device-to-device (D2D) communication.

The wireless communication system 100 may further include a core network device 130 that communicates with the base station, and the core network device 130 may be a 5G Core (5GC) device, for example, an Access and Mobility Management Function (AMF), an Authentication Server Function (AUSF), a User Plane Function (UPF), a Session Management Function (SMF). Alternatively, the core network device 130 may also be an Evolved Packet Core (EPC) device in an LTE network, for example, a Session Management Function + Core Packet Gateway (SMF + PGW-C) device of the core network. It should be understood that the SMF + PGW-C may simultaneously implement functions of the SMF and the PGW-C. In the process of network evolution, the above core network devices may be called as other names, or a new network entity may be formed by dividing the functions of the core network, which is not limited by the embodiments of the present disclosure.

The respective functional units in the communication system 100 may also establish a connection with each other through a next generation network (NG) interface to implement communication.

For example, the terminal device establishes an air interface connection with the access network device through the Uu interface for transmitting user plane data and control plane signaling. The terminal device can establish a control plane signaling connection with the AMF through the NG interface 1 (N1 for short). An access network device, such as a next generation radio access base station (gNB), can establish a user plane data connection with the UPF through an NG interface 3 (N3 for short). The access network device can establish a control plane signaling connection with the AMF through the NG interface 2 (N2 for short). The UPF may establish a control plane signaling connection with the SMF through the NG interface 4 (referred to as N4 for short). The UPF can interact user plane data with the data network through the NG interface 6 (N6 for short). The AMF may establish a control plane signaling connection with the SMF through the NG interface 11 (N11 for short). The SMF may establish a control plane signaling connection with the PCF through the NG interface 7 (referred to as N7 for short).

FIG. 1 exemplarily illustrates one base station, one core network device and two terminal devices. Alternatively, the wireless communication system 100 may include more base stations, and other number of terminal devices may be included within the coverage range of each base station, which is not limited in the embodiment of the present disclosure.

The 3GPP is studying non-terrestrial network (NTN) technology. The NTN generally uses satellite communication to provide communication services to terrestrial users. Compared with the terrestrial cellular communication, the satellite communication has many unique advantages. First of all, satellite communication is not restricted by the user's region. For example, general land communication cannot cover areas such as oceans, mountains, deserts where communication equipment cannot be installed or there is no communication coverage due to sparse population. For the satellite communication, because a satellite can cover a large area of the ground, and the satellites can orbit around the earth, every corner of the earth can be covered by satellite communication theoretically. Secondly, the satellite communication has great social value. The satellite communication can cover remote mountainous areas, poor and backward countries or regions at a lower cost, so that people in these areas can enjoy advanced voice communication and mobile Internet technology, which is conducive to narrow the digital divide relative to developed regions and prompt the development of these regions. Thirdly, satellite communication has a long distance, and the cost of communication does not increase significantly as the communication distance increases. At last, the satellite communication has high stability and is not affected by natural disasters.

The NTN technology can be combined with various communication systems. For example, the NTN technology may be combined with the NR system as an NR-NTN system. As another example, the NTN technology can be combined with an Internet of Things (IoT) system as an IoT-NTN system. As an example, an IoT-NTN system may include an NB-IoT-NTN system and an eMTC-NTN system.

FIG. 2 is a schematic architecture diagram of another communication system provided by an embodiment of the present disclosure.

As shown in FIG. 2, the communication system includes a terminal device 1101 and a satellite 1102, and wireless communication can be performed between the terminal device 1101 and the satellite 1102. The network formed between the terminal device 1101 and the satellite 1102 may also be referred to as an NTN. In the architecture of the communication system illustrated in FIG. 2, the satellite 1102 may have the function of a base station, and the terminal device 1101 and the satellite 1102 may communicate with each other directly. Under the system architecture, the satellite 1102 may be referred to as a network device. In some embodiments of the present disclosure, the communication system may include a plurality of network devices 1102, and the coverage range of each network device 1102 may include other number of terminal devices, which is not limited in the embodiments of the present disclosure.

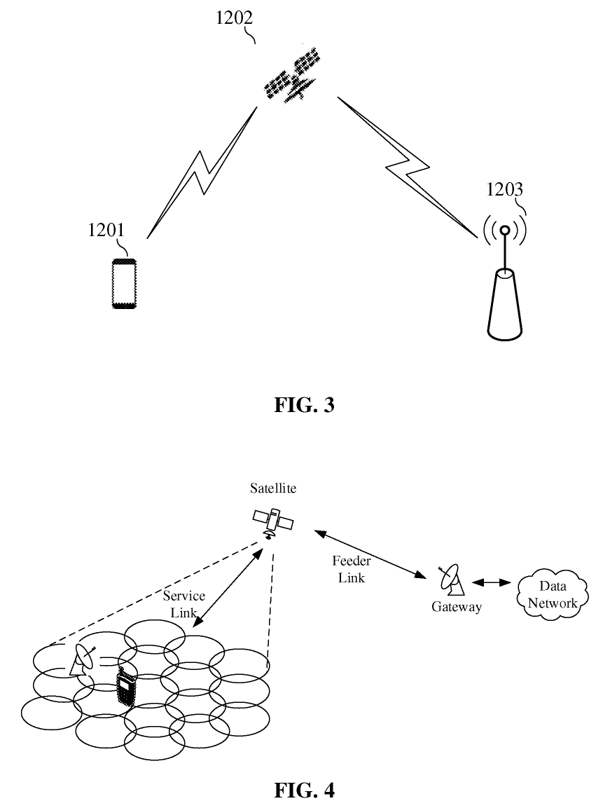

FIG. 3 is a schematic architecture diagram of another communication system provided by an embodiment of the present disclosure.

As illustrated in FIG. 3, the communication device includes a terminal device 1201, a satellite 1202 and a base station 1203, and wireless communication may be performed between the terminal device 1201 and the satellite 1202, and communication may be performed between the satellite 1202 and the base station 1203. The network formed between the terminal device 1201, the satellite 1202 and the base station 1203 may also be referred to as an NTN. In the architecture of the communication system illustrated in FIG. 3, the satellite 1202 may not have the function of a base station, and communication between the terminal device 1201 and the base station 1203 requires transferring through the satellite 1202. Under such system architecture, the base station 1203 may be referred to as a network device. In some embodiments of the present disclosure, the communication system may include a plurality of network devices 1203, and the coverage range of each network device 1203 may include other number of terminal devices, which is not limited in the embodiments of the present disclosure. The network device 1203 may be the network device 120 in FIG. 1.

It should be understood that the above-described satellite 1102 or satellite 1202 includes, but is not limited to: the Low-Earth Orbit (LEO) satellite, the Medium-Earth Orbit (MEO) satellite, the Geostationary Earth Orbit (GEO) satellite, a High Elliptical Orbit (HEO) satellite and so on. The satellite may use multiple beams to cover the ground, for example, one satellite may form dozens or even hundreds of beams to cover the ground. In other words, one satellite beam can cover a ground area with a diameter of tens to hundreds of kilometers to ensure the satellite coverage and increase the system capacity of the entire satellite communication system.

As an example, the altitude range of the LEO satellite may range from 500 kilometers to 1,500 kilometers, the corresponding orbital period may be about 1.5 hours to 2 hours, the signal propagation delay of single-hop communication between users may generally be less than 20 milliseconds, and the maximum satellite visibility time may be 20 minutes. The LEO satellite has a short signal propagation distance and low link loss, and do not require high transmission power of user terminals. The orbital altitude of the GEO satellite may be 35,786 km, the rotation period around the earth of the GEO satellite may be 24 hours, and the signal propagation delay of single-hop communication between users may generally be 250 milliseconds.

In order to ensure the satellite coverage and improve the system capacity of the entire satellite communication system, the satellites use multiple beams to cover the ground. One satellite can form dozens or even hundreds of beams to cover the ground, and a satellite beam can cover a ground area with a diameter of tens to hundreds of kilometers.

The Satellite can be classified into two types according to the functions thereof: transparent payload and regenerative payload. The transparent payload satellite only provides the functions of wireless frequency filtering, frequency conversion and amplification, and only provides transparent transporting of signals without changing the transported waveform signals. The regenerative payload satellite can provide the functions of demodulation/decoding, routing/conversion and encoding/modulation, in addition to the functions of radio frequency filtering, frequency conversion and amplification, and the regenerative payload satellite have some or all functions of the base station.

The NTN may include one or more gateways for communication between satellites and terminals.

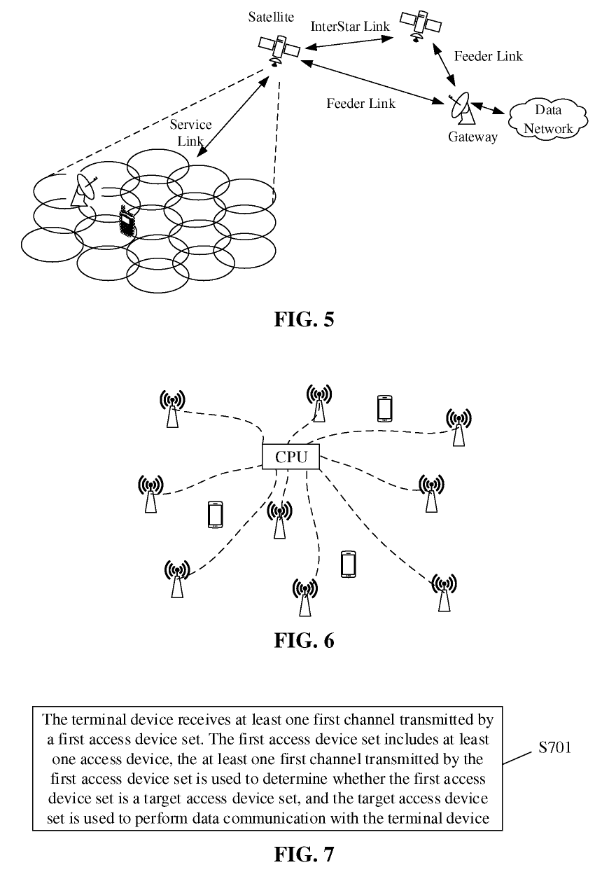

FIGS. 4 and 5 show schematic diagrams of NTN scenarios based on transparent payload satellite and regenerative payload satellite, respectively.

As shown in FIG. 4, in the NTN scenario based on the transparent payload satellite, the gateway and the satellite perform communication through a Feeder link, and the satellite and the terminal may perform communication through a service link. As shown in FIG. 5, in the NTN scenario based on a regenerative payload satellite, the satellites perform communication with each other through an InterStar link, the gateway and the satellite perform communication through a Feeder link, and the satellite and the terminal may perform communication through a service link.

In order to facilitate understanding of the technical solutions of the embodiments of the present disclosure, the related technologies of the embodiments of the present disclosure will be described below, and the related technologies below may be, as an optional solution, arbitrarily combined with the technical solutions of the embodiments of the present disclosure, and all of them belong to the scope of protection of the embodiments of the present disclosure.

It should be noted that FIGS. 1 to 5 illustrate systems to which the present disclosure is applicable only by way of example, and in practical, the methods shown in the embodiments of the present disclosure may also be applied to other systems. Further, the terms "system" and "network" are often used interchangeably herein. Herein, the term "and/or" is only an association relationship describing association objects, and means that there may be three relationships. For example, A and/or B may mean that A alone exists, A and B simultaneously exist, and B alone exists. In addition, the character "/" in this article generally indicates that the front and back related objects are in an "or" relationship. It should also be understood that the "indication" mentioned in the embodiments of the present disclosure may be a direct indication, an indirect indication, or may mean an associated relationship. For example, A indicates B, which may mean that A directly indicates B, for example, B can be acquired by A, and may also mean that A indicates B indirectly, for example A indicates C, and B can be acquired through C, and may also means that there is an association relationship between A and B. It should also be understood that "correspondence" mentioned in the embodiments of the present disclosure may indicate that there is a direct correspondence or indirect correspondence between the objects, may indicate that there is a correlation relationship between the two objects, or may indicate a relationship of indicating and being indicated, configuring and being configured, or the like. It should also be understood that the "predefined" or "predefined rules" mentioned in the embodiments of the present disclosure may be implemented by storing corresponding codes, tables in advance in devices (e.g., including terminal devices and network devices), or other ways that can be used to indicate relevant information, and the present disclosure does not limit specific implementations thereof. For example, the “predefined” may refer to defining in the protocol. It should also be understood that in the embodiment of the present disclosure, the "protocol" may refer to a standard protocol in the field of communication, which may include, for example, an LTE protocol, an NR protocol, and related protocols applied in future communication systems, which is not limited in the present disclosure.

In order to facilitate understanding of the technical solutions of the embodiments of the present disclosure, the related technologies of the embodiments of the present disclosure will be described below, and the related technologies below can be, as an optional solution, arbitrarily combined with the technical solutions of the embodiments of the present disclosure, and all of them belong to the scope of protection of the embodiments of the present disclosure.

A cell-free radio access network (cell-free RAN) is defined below.

As shown in FIG. 6, a cell-free radio access network is a network composed of a large number of distributed low-cost and low-power radio access devices. The access device may also be called as an AP. Among them, the AP can implement simple physical layer functions such as wireless signal transmission and reception, channel estimation, downlink precoding and uplink signal detection. In addition, as shown in FIG. 6, different APs are connected to one or more central processing devices (which may also be referred to as central processing units (CPUs)) through backhaul links. The CPUs can implement complex physical layer functions such as data distribution and merging, signal modulation and demodulation, information bit coding and decoding and the like to the APs, so that all APs can jointly provide services for each terminal at the same time. As the number of APs increases, the influence of the cell boundary is gradually eliminated, and the concept of a "cell-free" system is formed, which significantly improves system capacity and spectrum efficiency.

In order to facilitate understanding of the technical solutions of the embodiments of the present disclosure, the technical solutions of the present disclosure are described in detail below with reference to specific embodiments. The above related technologies can be, as an optional solution, arbitrarily combined with the technical solutions of the embodiments of the present disclosure, and all of them belong to the scope of protection of the embodiments of the present disclosure. The embodiments of the present disclosure include at least some of the following.

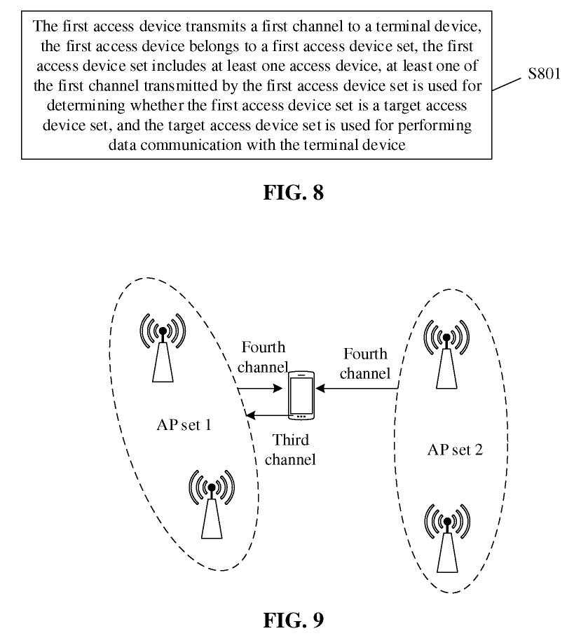

As shown in FIG. 7, the wireless communication method provided by the embodiment of the present disclosure is applied to a terminal device, and includes an operation S701.

At S701, the terminal device receives at least one first channel transmitted by a first access device set. The first access device set includes at least one access device, the at least one first channel transmitted by the first access device set is used to determine whether the first access device set is a target access device set, and the target access device set is used to perform data communication with the terminal device.

As shown in FIG. 8, the wireless communication method provided by the embodiment of the present disclosure is applied to the first access device, and includes an operation S801.

At S801, the first access device transmits a first channel to a terminal device, the first access device belongs to a first access device set, the first access device set includes at least one access device, at least one of first channels transmitted by the first access device set is used for determining whether the first access device set is a target access device set, and the target access device set is used for performing data communication with the terminal device.

Hereinafter, the wireless communication method shown in FIG. 7 or FIG. 8 will be further described.

In an embodiment of the present disclosure, the access devices in the cell-free radio access network are configured as at least two access device sets, that is, AP sets, one AP set includes at least one AP, and the first AP set is any AP set among the at least two AP sets.

In an embodiment of the present disclosure, the central processing device may configure an AP set for an AP in a cell-free radio access network. In some embodiments, the AP set may be configured based on the distance between different APs. In one example, the AP set includes a master AP, and an AP within a first distance range from the master AP belongs to the same AP set as the master AP.

A first AP transmits a first channel, and the first AP belongs to a first AP set. When the first AP transmits the first channel, the first AP set transmits at least one first channel to the terminal device, and the at least one first channel is used by the terminal device to determine whether the first AP set is a target AP set.

The first AP set includes at least one AP, and the at least one first channel transmitted by the first AP set may be understood as at least one first channel transmitted by at least one AP in the first AP set, and one AP transmits one first channel.

In an embodiment of the present disclosure, the terminal device detects the first channel, and when the terminal device receives at least one first channel transmitted by the AP set, it may be regarded that the terminal device has received at least one first channel transmitted by the first AP set.

In an embodiment of the present disclosure, the terminal device may receive at least one first channel (that is, one or more first channels) transmitted by the first AP set.

In some embodiments, the manner in which the first AP set transmits the at least one first channel includes one of: Transmission mode 1 where the master AP of the first AP set transmits the first channel; and Transmission mode 2 where each AP of the first number of APs in the first AP set transmits a first channel.

In transmission mode 1, the first channel transmitted by the first AP set includes only one first channel, and the master AP of the first AP set transmits the first channel, and the terminal device receives one first channel transmitted by the first AP set. At this time, the first AP is the master AP in the first AP set.

In transmission mode 2, the first channel transmitted by the first AP set includes a first number of first channels, the first number is greater than 1 and less than or equal to a second number, and the second number is the number of APs included in the first AP set. The first number of APs in the first AP set that transmit the first channel includes a master AP and at least one secondary AP in the first AP set, and the secondary AP is an AP other than the master AP in the first AP set. The terminal device receives the first number of first channels transmitted by the first AP set. In this case, the first AP is any AP that transmits the first channel in the first AP set.

In an embodiment of the present disclosure, the first AP set may periodically transmit the first channel, so that the terminal device within the coverage range of the first AP set can receive the first channel.

It can be understood that each AP set in the cell-free radio access network periodically transmits the first channel, and the terminal device can detect the first channel transmitted by one or more AP sets. Here, the AP set, the first channel of which is detected by the terminal device, is referred to as the first AP set.

After receiving the at least one first channel transmitted by the first AP set, the terminal device determines, through the received at least one first channel, whether the first AP set can be used as a target AP set for data communication with the terminal device.

The target AP set may be understood as an AP set that provides services for a terminal device, and an AP other than the AP in the target AP set in the cell-free radio network does not provide services for the terminal device.

In the embodiment of the present disclosure, after the terminal device determines the target AP set and establishes an association relationship with the target AP set, the terminal device establishes an association relationship with the AP in the target AP set, and the AP in the target AP set provides a service to the terminal device after establishing an association with the terminal device.

In some embodiments, the service provided by the AP in the target AP set for the terminal device includes at least one of the following simple physical layer functions: transmission and reception of wireless signals, channel estimation, downlink precoding, and uplink signal detection. Further, the AP in the target AP set is connected to one or more CPUs through a backhaul link, to distribute and combine data of the terminal device transmitted or received by the AP in the target AP set, so that the AP in the target AP set jointly provides services to the terminal device.

It is understood that the terminal device may receive a first channel transmitted by at least one first AP set, and one first AP set transmits at least one first channel.

Upon receiving a first channel transmitted by a first AP set, the terminal device determines whether the first AP set can be a target AP set corresponding to the terminal device.

When the terminal device receives the first channels transmitted by multiple first AP sets, the terminal device determines whether each of the multiple first AP sets can be a target AP set corresponding to the terminal device, or selects a first AP set that can be the target AP set from the multiple first AP sets.

In the wireless communication method according to the embodiment of the present disclosure, the terminal device determines whether the first AP set is a target AP set for data communication with the terminal device based on at least one received first channel transmitted by the first AP set, and services is provided for the terminal device based on the AP set, and not all APs provides services for the terminal device, thereby reducing signaling overhead and computation complexity while realizing good network scalability.

In some embodiments, a first received power is used to determine whether the first AP set is the target AP set, and the first received power is determined based on a received power of the first channel which is transmitted by the first AP set and received by the terminal device.

It is understood that if the first channel transmitted by the first AP set includes one first channel, the first received power is the received power of the first channel received by the terminal device. When the first channel transmitted by the first AP set includes multiple first channels, the first received power is determined based on multiple received powers, which is a received power of each of the multiple first channels, and in one example, the first received power may be the largest received power among the multiple received powers of the multiple first channels, or may be a received power weighted by the multiple received powers.

In some embodiments, it is determined that the first AP set is the target AP set when the first received power meets at least one of following conditions.

The first received power is greater than a received power threshold.

The first received power is a maximum value among multiple first received powers.

In an example, after the terminal device receives the first channel of the first AP set, and if the first received power of the first AP set is greater than a received power threshold, the first AP set is a target AP set.

In an example, after the terminal device receives the first channels of multiple first AP sets, the terminal device compares the first received powers of the multiple first AP sets, and determines the first AP set corresponding to the largest first received power as the target AP set.

In an example, after the terminal device receives the first channels of multiple first AP sets, the terminal device compares the first received powers of the multiple first AP sets, and comprises the first received powers of the multiple first AP set with a received power threshold, and when the maximum first received power is greater than the received power threshold, determines the first AP set corresponding to the maximum first received power as the target AP set.

In the wireless communication method according to the embodiment of the present disclosure, whether the first AP set is a target AP set is determined based on the first received power determined by the received power of the first channel of the first AP set, and when the distance between the first AP set and the terminal device affects the first received power, it is determined that the first AP set can be used as the target AP set based on the distance between the first AP set and the terminal device, so that an AP set capable of providing high-quality services to the terminal device is determined.

In some embodiments, the first channel carries a downlink synchronization signal, and the downlink synchronization signal is used by the terminal device to perform downlink synchronization with the AP set that transmits the first channel.

When the first channel carries a downlink synchronization signal, if the terminal device determines that a first AP set is the target AP set, the terminal device may perform downlink synchronization with the first AP set through the downlink synchronization signal carried by the first channel transmitted by the first AP set, thereby realizing downlink synchronization with the target AP set.

It is understood that the downlink synchronization signal is used by the terminal device to perform time-frequency synchronization with the first AP set.

In some embodiments, downlink synchronization signals in the first channels transmitted by different AP sets are transmitted using different first pseudo-random sequences.

The first pseudo-random sequence used in the downlink synchronization signal in the first channel is used by the terminal device to identify the first AP set which transmits the first channel.

It can be understood that when different APs in one AP set transmit first channels, first pseudo-random sequences used by downlink synchronization signals carried by the first channels transmitted by the different APs are identical.

After receiving the first signal, the terminal device identifies the AP set which transmits the first channel by the first pseudo-random sequence used by the downlink synchronization signal in the first signal. The terminal device may detect a synchronization signal on the first channel through a first pseudo-random sequence corresponding to an AP set, and determine that the first channel transmitted by the first AP set is received if the synchronization signal is detected.

In an example, the first pseudo-random sequence corresponding to AP set 1 is sequence A, and the first pseudo-random sequence corresponding to AP set 2 is sequence B. When detecting the downlink synchronization signal carried by the first channel, the terminal device detects the downlink synchronization signal using sequence A and sequence B, and determines that the downlink synchronization signal transmitted by AP set 1 is received if the downlink synchronization signal is detected by sequence A, and determines that the downlink synchronization signals transmitted by AP set 1 and AP set 2 (including downlink synchronization signal 1 of AP set 1 and downlink synchronization signal 2 transmitted by AP set 2) are received if the downlink synchronization signal is detected by sequence A and sequence B, and distinguish downlink synchronization signal 1 of AP set 1 and downlink synchronization signal 2 transmitted by AP set 2 by sequence A and sequence B.

In the embodiment of the present disclosure, the first pseudo-random sequence includes a pseudo-random sequence having good autocorrelation and cross-correlation characteristics, such as the m sequence and the Gold sequence.

In some embodiments, the first channel carries at least one of: first indication information indicating a position of a first resource, the first resource is a resource occupied by transmission of the first channel, and the position of the first resource is used for time domain positioning and/or frequency domain positioning; second indication information indicating a second resource, the second resource is a resource occupied by transmission of a second channel, and the second channel is a wireless channel after the first channel; first information used by the terminal device to determine a first timing advance TA.

The first indication information may indicate a first time domain position and/or a first frequency domain position, the first time domain position is a time domain position of the first resource, the first frequency domain position is a frequency domain position of the first resource, the first time domain position is used for time domain positioning of the terminal device, and the second time domain position is used for frequency domain positioning of the terminal.

Time domain positioning can be regarded as establishing a relationship between time and a time domain unit, and the time domain unit includes at least one of a frame, a subframe, a slot, and a symbol, and the terminal device determines a time domain unit corresponding to a time through the time domain positioning.

Frequency domain positioning can be regarded as establishing a relationship between a frequency point and a frequency domain unit, and the frequency domain unit includes at least one of a scheduling block (SB), a resource block (RB), and a resource element (RE). The terminal device determines a frequency domain unit corresponding to a frequency point through the frequency domain positioning.

The second indication information is used to indicate a location and/or size of the second resource. If the second indication information indicates the position of the second resource, the second indication information may directly indicate the location of the second resource or may indicate an offset, which is an offset of the position of the second resource relative to a reference channel in the time domain and/or the frequency domain.

In an embodiment of the present disclosure, the second channel may include at least one of a third channel, a fourth channel, a fifth channel and a sixth channel, and correspondingly, the second resource may include at least one of a third resource occupied by transmission of the third channel, a fourth resource occupied by transmission of the fourth channel, a fifth resource occupied by transmission of the fifth channel, and a sixth resource occupied by transmission of the sixth channel. The third channel is a channel transmitted by the terminal device to the target AP set for requesting association with the target AP set. The fourth channel is a channel transmitted by the first AP set or the target AP set to the terminal device for carrying first random access configuration information. The first random access configuration information is configuration information of a random access procedure in which the terminal device accesses the first AP set. The fifth channel is used to schedule the fourth resource. The sixth channel is used to indicate the fifth resource.

It can be understood that a resource may include a real-time domain resource which is a position of the resource in the time domain, and a frequency domain resource which is a position of the resource in the frequency domain.

For a resource among the second resource, the second indication information may indicate a position of the resource in the time domain and/or a position of the resource in the frequency domain, that is, indicate the time-domain resource and/or the frequency-domain resource included in the resource.

Note that multiple channels included in the second channel may be combined without collision.

In an example, the second channel includes a third channel and a fourth channel, and the second indication information indicates a time domain position and a frequency domain position of the third resource, and a time domain position and a frequency domain position of the fourth resource.

In an example, the second channel includes a third channel and a fifth channel, and the second indication information indicates a time domain position and a frequency domain position of the third resource and a time domain position and a frequency domain position of the fifth resource, and the fifth channel schedules a time domain position and a frequency domain position of the fourth resource.

In an example, the second channel includes a sixth channel, and the second indication information indicates a time domain position and a frequency domain position of the sixth resource, and the terminal device determines a time domain position and a frequency domain position of the fifth resource based on the sixth channel, and the fifth channel transmitted on the fifth resource schedules a time domain position and a frequency domain bit of the fourth resource.

In an example, the second channel includes a third channel, a fourth channel, a fifth channel and a sixth channel, and the second indication information indicates a time domain position and a frequency domain position of the third resource, a time domain position of the fourth resource, a frequency domain position of the fifth resource, and a time domain position and a frequency domain position of the sixth resource. The terminal device receives the sixth channel based on the sixth resource, and the sixth channel indicates the frequency domain position of the fifth resource. The terminal device receives the fifth channel based on the fifth resource, and the fifth channel schedules the frequency domain position of the fourth resource.

In case where a time domain resource or a frequency domain resource of a second resource is not specified, the second resource includes a time domain resource and a frequency domain resource.

The first information is used to determine a first TA, and the first TA can be regarded as an open-loop TA, and the open-loop TA can be used by the terminal device in the NTN scenario to perform uplink time domain synchronization, thereby adjusting the transmission time of uplink transmission in the NTN scenario.

The first information may include at least one of satellite ephemeris information and public TA information.

In the embodiment of the present disclosure, if the wireless communication method provided in the embodiment of the present disclosure is applied to the NTN, the first channel carries the first information, otherwise, the first channel may not carry the first information.

In some embodiments, if it is determined that the first AP set is the target AP set, based on the method shown in FIG. 7, the method further includes an operation that the terminal device transmits a third channel to the first AP set, and the third channel is used by the terminal device to establish an association relationship with the first AP set.

In some embodiments, if it is determined that the first AP set is the target AP set, based on the method shown in FIG. 8, the method further includes an operation that the first AP receives a third channel transmitted by the terminal device, and the third channel is used by the terminal device to establish an association relationship with the first AP set.

When the terminal device determines that the first AP set is the target AP set based on the first channel transmitted by the first AP set, the terminal device transmits the third channel to the first AP set. In some embodiments, the third channel may be a physical random access channel (PRACH).

The terminal device establishes an association relationship with the first AP set, so that the first AP set becomes the target AP set.

In an embodiment of the present disclosure, when the terminal device establishes an association relationship with the first AP set, each AP in the first AP set establishes an association relationship with the terminal device, so that each AP in the first AP set can provide a service to the terminal device.

If the transmission mode of the first channel is transmission mode 1, the terminal device transmits a third channel to the master AP of the first AP set or each AP of the first AP set, and the master AP or each AP of the first AP set receives a third channel, and the first AP set establishes an association relationship with the terminal device based on the received the third channel.

If the transmission mode of the first channel is transmission mode 2, the terminal device transmits a third channel to an AP of the first AP set, and each AP of the first AP set receives the third channel, and establishes an association relationship with the terminal device based on the received third channel, to establish an association relationship between the first AP set and the terminal device.

In an embodiment of the present disclosure, the first AP set may establish an association relationship with the terminal device through a random access procedure.

In some embodiments, the third channel carries an uplink synchronization signal, and the uplink synchronization signal is used by the terminal device to perform uplink synchronization with the target AP set.

The third channel may be transmitted using a second pseudo-random sequence. The terminal device transmits the third channel using the second pseudo-random sequence. After the first AP set transmits the first channel, the first AP set may detect the third channel by using the second pseudo-random sequence. If the third channel is detected by using the second pseudo-random sequence, the first AP set may implement uplink time synchronization with the terminal device which transmits the third channel.

In some embodiments, the third resource occupied by transmission of the third channel is determined based on at least one of: factor 3A, a first resource that is a resource occupied by transmission of the first channel, and a first offset that is an offset of the third resource relative to the first resource in the time domain and/or the frequency domain; and factor 3B, third indication information for indicating a position and/or a size of the third resource in the frequency domain and/or the time domain.

For factor 3A, if the first offset is an offset of the third resource with respect to the first resource in the time domain, the first offset is a first time domain offset. If the first offset is an offset of the third resource with respect to the first resource in the frequency domain, the first offset is a first frequency domain offset. If the first offset is an offset of the third resource relative to the first resource in the time domain and the frequency domain, the first offset includes a first time domain offset and a first frequency domain offset. The third time domain position is obtained by shifting the first time domain offset with respect to the first time domain position, and the third frequency domain position is obtained by shifting the first frequency domain offset with respect to the first frequency domain position. The third time domain position is a position of the third resource in the time domain, and the third frequency domain position is a position of the third resource in the frequency domain.

Note that, in the embodiment of the present disclosure, the unit of the offset in the time domain is a time domain unit, and the unit of the offset in the frequency domain is a frequency domain unit.

The third resource is determined by determining the following four contents: a third time domain position which is a position of the third resource in the time domain; a third frequency domain position which is a position of the third resource in the frequency domain; a third time domain size which is a size of the third resource in the time domain; and a third frequency domain size which is a size of the third resource in the frequency domain.

The above four contents of the third resource may be determined based on one or more of factors 3A and 3B when the factors 3A and 3B do not conflict.

The third time domain position and the third frequency domain position of the third time domain resource and the third frequency domain resource may be determined based on a combination of the first offset and the first resource and/or the third indication information.

In an example, the first offset and the first resource are used to determine the third time domain position and the third frequency domain position.

In an example, the third indication information is used to determine the third time domain position and the third frequency domain position.

In an example, the first offset and the first resource are used to determine the third time domain position, and the third indication information is used to determine the third frequency domain position.

In an example, the first offset and the first resource are used to determine the third frequency domain position, and the third indication information is used to determine the third time domain position.

Assuming that the first offset and the first resource are used to determine the third time domain position and the third frequency domain position, and the first offset includes the first time domain offset and the first frequency domain offset, the terminal device determines the position of the third resource based on the first offset and the first resource. The terminal device determines the third time domain position based on the first time domain offset and the position (that is, the first time domain position) of the first resource in the time domain. The terminal device determines the third frequency domain position based on the first frequency domain offset and the position (that is, the first frequency domain position) of the first resource in the frequency domain.

Assuming that the third indication information is used to determine the third time domain position and the third frequency domain position, the terminal device determines the position of the third resource based on the third indication information.

Assuming that the first offset and the first resource are used to determine the third time domain position, and the third indication information is used to determine the third frequency domain position, the terminal device determines the third time domain position based on the first time domain offset and the first time domain position, and determines the third frequency domain position based on the third indication information.

Assuming that the first offset and the first resource are used to determine the third frequency domain position, and the third indication information is used to determine the third time domain position, the terminal device determines the third frequency domain position based on the first frequency domain offset and the first frequency domain position, and determines the third time domain position based on the third indication information.

The third time domain size may be a set first size or may be indicated by the third indication information.

The third frequency domain size may be a set second size or may be indicated by the third indication information.

In the embodiment of the present disclosure, different methods of determining the third time domain position and the third frequency domain position of the third resource and different methods of determining the size of the third resource in the time domain and the size of the third resource in the frequency domain may be combined with each other without collision.

In an example, the third time domain position is determined based on the first time domain position and the first time domain offset, the third frequency domain position is determined based on the third indication information, the size of the third resource in the time domain is a set first size, and the size of the third resource in the frequency domain is indicated by the third indication information.

In an example, the third time domain resource, the third frequency domain resource, and the size of the third resource in the time domain and the frequency domain are indicated by the third indication information.

In an example, the third time domain position is determined based on the first time domain position and the first time domain offset, the third frequency domain position is determined based on the first frequency domain position and the first frequency domain offset, the size of the third resource in the time domain is the first size, and the size of the third resource in the frequency domain is the second size.

In some embodiments, at least one of the following is agreed by a protocol or indicated by the first channel: the first offset; and the third indication information.

In some embodiments, based on the wireless communication method shown in FIG. 7, the method further includes an operation that the terminal device receives a fourth channel transmitted by the first AP set. The fourth channel is used to carry first random access configuration information corresponding to the first AP set, and the first random access configuration information is used by the terminal device to access the first AP set through a random access procedure.

In some embodiments, based on the wireless communication method shown in FIG. 7, the method further includes an operation that the first AP sends a fourth channel to the terminal device. The fourth channel is used for carrying first random access configuration information corresponding to the first AP set, and the first random access configuration information is used for a random access procedure in which the terminal device accesses the first AP set.

Regarding the method of transmitting the fourth channel, reference may be made to the method of transmitting the first channel, and the description thereof will not be repeated here.

The fourth channel may be a physical downlink shared channel (PDSCH).

After receiving the fourth channel transmitted by the first AP set, the terminal device performs a random access procedure for accessing the first AP set based on the first random access configuration information carried by the fourth channel, to be associated with the first AP set.

In the embodiment of the present disclosure, a first random access procedure configuration message is a cell-level system message, and is not a message for the current terminal device.

In some embodiments, the first random access configuration information includes at least one of: a first frequency range which is a frequency range in which downlink channel transmission in the random access procedure is located; and a second frequency range which is a frequency range in which the uplink channel transmission in the random access procedure is located.

For the terminal device, the terminal device transmits an uplink channel transmission in the random access procedure to the first AP set based on the first frequency range, and receives a downlink channel transmission transmitted by the first AP set based on the first frequency range.

The first AP set receives an uplink channel transmission of the random access procedure in a second frequency range, and transmits a downlink channel transmission in the random access procedure to the terminal device based on the first frequency range.

Different first AP sets transmit different pieces of first random access procedure configuration information to the terminal device through the fourth channel.

In some embodiments, the fourth channel is further used to carry at least one of: fourth indication information for indicating a time domain position of a fourth resource, the fourth resource is a resource occupied by transmission of the fourth channel, and the time domain position of the fourth resource is used for time domain positioning; first information used by the terminal device to determine a first TA; and a random Access Response (RAR) message.

According to the embodiment of the present disclosure, only one piece of information may be configured for indicating the same function or purpose, and repeated configuration is not required. For example, one of the first channel and the fourth information carries the first information. For another example, one of the first channel and the fourth channel carries information for time domain positioning. For the sake of simplicity, detailed examples will not be described later.

The RAR message may carry at least one of a second TA, uplink grant scheduling information, and a temporary identifier used by the random access procedure. The second TA is a TA for the terminal device, and can be regarded as a closed-loop TA.

In the embodiment of the present disclosure, if the terminal device is applied to a non-NTN network, the terminal device performs timing advance based on the second TA, and if the terminal device is applied to an NTN network, the terminal device performs timing advance based on the first TA and the second TA to adjust the transmission time of uplink transmission.

In some embodiments, the first TA is used to adjust a transmission time of a first uplink transmission, and the first uplink transmission is an uplink transmission after receiving the first information.

If the first information is carried in the first channel, the channel on which the first TA acts includes the fourth channel and uplink transmission in the random access procedure.

If the first information is carried in the fourth channel, the information on which the first TA acts includes uplink transmission in the random access procedure.

In some embodiments, reception of the fourth channel precedes transmission of a third channel, the third channel is a channel transmitted by the terminal device to the first AP set in case that it is determined that the first AP set is the target AP set, and the third channel is used by the terminal device to establish an association relationship with the target AP set.

Alternatively, transmission of the third channel precedes reception of the fourth channel.

If the reception of the fourth channel precedes the transmission of the third channel, the first AP set transmits the fourth channel to the terminal device after transmitting the first channel, and each of multiple first AP sets transmits the fourth channel carrying the first random access procedure configuration information. In this case, the terminal device attempts to receive the fourth channel transmitted by the first AP set. The first AP set does not determine whether it is the target AP set, and attempts to send the first random access procedure configuration information to the terminal device.

At this time, the multiple first AP sets include AP set 1 and AP set 2. After AP set 1 and AP set 2 transmit the first channel to the terminal device, as described in FIG. 9, AP set 1 and AP set 2 respectively transmit a fourth channel to the terminal device. In case that the terminal device determines that AP set 1 is the target AP set, the terminal device transmits a third channel to AP set 1 to realize uplink synchronization between the terminal device and AP set 1.

If the reception of the fourth channel is followed by the transmission of the third channel, and after the first AP set transmits the first channel, the terminal device determines the first AP set as the target AP set based on the received first channel, transmits the third channel to the first AP set determined as the target AP set, and the first AP set determined as the target AP set transmits the fourth channel to the terminal device. In this case, the AP set determined as the target AP set transmits a fourth channel to the terminal device to provide first random access procedure configuration information thereof, and the terminal device receives the fourth channel transmitted by only the first AP set determined as the target AP set, thereby avoiding unnecessary channel transmission.

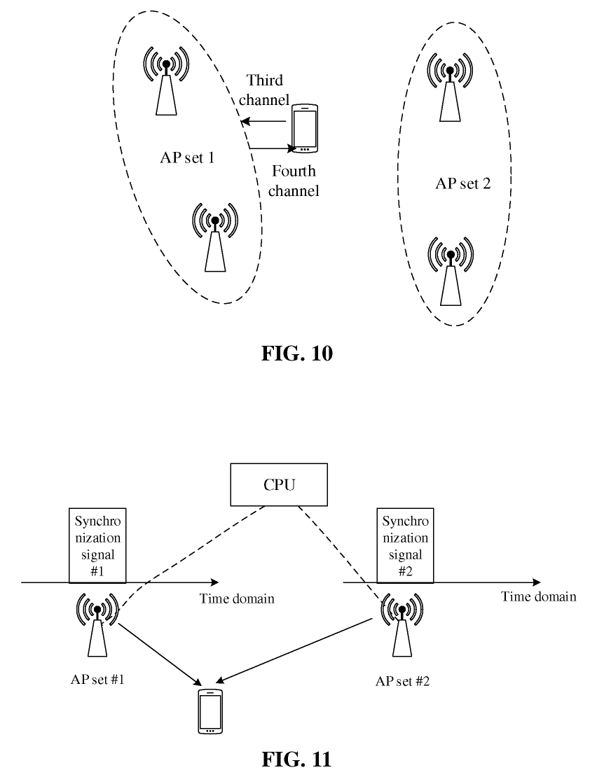

Based on the AP set shown in FIG. 10, after AP set 1 and AP set 2 transmit the first channel to the terminal device, and in case that the terminal device determines that the AP set 1 is the target AP set, the terminal device transmits the third channel to the AP set 1 as described in FIG. 9, and the AP set 1 transmits the fourth channel to the terminal device based on the received third channel, so as to realize uplink synchronization between the terminal device and the AP set 1.

In some embodiments, a fourth resource occupied by transmission of the fourth channel is determined based on at least one of: factor 4A, a first resource that is a resource occupied by transmission of the first channel, and a second offset that is an offset of the fourth resource relative to the first resource in the time domain and/or the frequency domain; and factor 4B, a third resource which is a resource occupied by a transmission of a third channel preceding the fourth channel, and a third offset which is an offset of the fourth resource relative to the third resource in the time domain and/or the frequency domain; factor 4C, fifth indication information for indicating a position and/or size of the fourth resource in the frequency domain and/or the time domain; and factor 4D, a fifth channel for scheduling the fourth channel.

For factor 4A, if the second offset is an offset of the fourth resource relative to the first resource in the time domain, the second offset is a second time domain offset. If the second offset is an offset of the fourth resource relative to the first resource in the frequency domain, the second offset is a second frequency domain offset. If the second offset is an offset of the fourth resource relative to the first resource in the time domain and the frequency domain, the second offset includes a second time domain offset and a second frequency domain offset. The fourth time domain position is obtained by offsetting the first time domain position by the second time domain offset, and the fourth frequency domain position is obtained by offsetting the first frequency domain position by the second frequency domain offset. The fourth time domain position is a position of the fourth resource in the time domain, and the fourth frequency domain position is a position of the fourth resource in the frequency domain.

For factor 4B, if the third offset is an offset of the fourth resource with respect to the third resource in the time domain, the third offset is a third time domain offset. If the third offset is an offset of the fourth resource with respect to the third resource in the frequency domain, the third offset is a third frequency domain offset. If the third offset is an offset of the fourth resource with respect to the third resource in the time domain and the frequency domain, the third offset includes a third time domain offset and a third frequency domain offset. The fourth time domain position is obtained by offsetting the third time domain position by the third time domain offset, and the fourth frequency domain position is obtained by offsetting the third frequency domain position by the third frequency domain offset. The third time domain position is a position of the third resource in the time domain, and the third frequency domain position is a position of the third resource in the frequency domain.

For factor 4D, the fifth channel is a downlink transmission channel, for example: PDCCH, preceding the fourth channel.

In the embodiment of the present disclosure, the fourth resource is determined by determining the following four contents: a fourth time domain position which is a position of the fourth resource in the time domain; a fourth frequency domain position which is a position of the fourth resource in the frequency domain; a fourth time domain size which is a size of the fourth resource in the time domain; a fourth frequency domain size which is a size of the fourth resource in the frequency domain.

The above four contents of the fourth resource may be determined based on one or more of the factors 4A, 4B, 4C, and 4D in case where the factors 4A, 4B, 4C, and 4D do not conflict.

In an example, the fourth time domain position, the fourth frequency domain position, the fourth time domain size, and the fourth frequency domain size are indicated by the fifth indication information.

In an example, the fourth time domain position, the fourth frequency domain position, the fourth time domain size, and the fourth frequency domain size are scheduled by the fifth channel.

In an example, the fourth time domain position is determined based on the first time domain position and the second time domain offset, the fourth frequency domain position is determined based on the third time domain position and the third frequency domain position, the fourth time domain size is indicated by the fifth indication information, and the fourth frequency domain size is scheduled by the fifth channel.

In an example, the fourth time domain position is determined based on the first time domain position and the second time domain offset, the fourth frequency domain position is determined based on the first time domain position and the second frequency domain position, and the fourth time domain size and the fourth frequency domain size are indicated by the fifth indication information.

In some embodiments, at least one of the following is agreed by a protocol or indicated by the first channel: the second offset; the third offset; and the fifth indication information.

In some embodiments, the fifth channel includes at least one of: sixth indication information for indicating a position and/or a size of the fourth resource in the frequency domain and/or the time domain; a fourth offset which is an offset of the fourth resource relative to a fifth resource occupied by a transmission of the fifth channel in the time domain and/or the frequency domain.

When the fifth channel schedules the fourth resource, the fifth channel may schedule at least one of four contents of the fourth resource, and the fifth channel may directly indicate the contents to be scheduled based on the sixth indication information, or may indicate the contents to be scheduled by a fourth offset.

The fourth offset includes a fourth time domain offset and/or a fourth frequency domain offset, and the fourth time domain offset is an offset of the fourth time domain position with respect to the fifth time domain position, that is, an offset of the fourth resource with respect to the fifth resource in the time domain. The fourth frequency domain offset is an offset of the fourth frequency domain position with respect to the fifth frequency domain position, that is, an offset of the fourth resource with respect to the fifth resource in the frequency domain. The fifth time domain position is a position of the fifth resource in the time domain, and the fifth frequency domain position is a position of the fifth resource in the frequency domain.

In some embodiments, a fifth resource occupied by transmission of the fifth channel is determined based on at least one of: factor 5A, the first resource, and a fifth offset which is an offset of the fifth resource relative to the first resource in the time domain and/or the frequency domain; factor 5B, the third resource, and a sixth offset which is an offset of the fifth resource relative to the third resource in the time domain and/or the frequency domain; factor 5C, seventh indication information for indicating a position and/or size of the fifth resource in the time domain and/or the frequency domain; and Factor 5D, a sixth channel for indicating a position and/or size of the fifth resource in the time domain and/or the frequency domain.

For factor 5A, if the fifth offset is an offset of the fifth resource in the time domain with respect to the first resource, the fifth offset is a fifth time domain offset. If the fifth offset is an offset of the fifth resource in the frequency domain with respect to the first resource, the fifth offset is a fifth frequency domain offset. If the fifth offset is an offset of the fifth resource in the time domain and the frequency domain relative to the first resource, the fifth offset includes a fifth time domain offset and a fifth frequency domain offset. The fifth time domain position is obtained by shifting the first time domain position by the fifth time domain offset, and the fifth frequency domain position is obtained by shifting the first frequency domain position by the fifth frequency domain offset. The fifth time domain position is a position of the fifth resource in the time domain, and the fifth frequency domain position is a position of the fifth resource in the frequency domain.

For factor 5B, if the sixth offset is an offset of the fifth resource in the time domain with respect to the third resource, the sixth offset is a sixth time domain offset. If the sixth offset is an offset of the fifth resource in the frequency domain with respect to the third resource, the sixth offset is a sixth frequency domain offset. If the sixth offset is an offset of the fifth resource in the time domain and the frequency domain relative to the third resource, the sixth offset includes a sixth time domain offset and a sixth frequency domain offset. The fifth time domain position is obtained by shifting the third time domain position by the sixth time domain offset, and the fifth frequency domain position is obtained by shifting the third frequency domain position by the sixth frequency domain offset.

For factor 5D, the sixth channel is the downlink transmission channel, for example PBCH, preceding the fifth channel.

In the embodiment of the present disclosure, the fifth resource is determined by determining the following four contents: a fifth time domain position which is a position of the fifth resource in the time domain; a fifth frequency domain position which is a position of the fifth resource in the frequency domain; a fifth time domain size which is a size of the fifth resource in the time domain; a fifth frequency domain size which is a size of the fifth resource in the frequency domain.

The above four contents of the fifth resource may be determined based on one or more of the factors 5A, 5B, 5C, and 5D in case where the factors 5A, 5B, 5C, and 5D do not conflict.

In an example, the fifth time domain position, the fifth frequency domain position, the fifth time domain size, and the fifth frequency domain size are indicated by the seventh indication information.

In an example, the fifth time domain position, the fifth frequency domain position, the fifth time domain size, and the fifth frequency domain size are indicated by the sixth channel.

In an example, the fifth time domain position is determined based on the first time domain position and the fifth time domain offset, the fifth frequency domain position is determined based on the third time domain position and the sixth frequency domain position, the fifth time domain size is indicated by the seventh indication information, and the fifth frequency domain size is indicated by the sixth channel.

In an example, the fifth time domain position is determined based on the first time domain position and the fifth time domain offset, the fifth frequency domain position is determined based on the first time domain position and the fifth frequency domain position, and the fifth time domain size and the fifth frequency domain size are indicated by the seventh indication information.

In some embodiments, at least one of the following is agreed by a protocol or indicated by the first channel: the fifth offset; the sixth offset; and seventh indication information.

In some embodiments, the sixth channel includes at least one of: eighth indication information for indicating a position and/or a size of the fifth resource in the time domain and/or the frequency domain; a seventh offset which is an offset of the fifth resource relative to a sixth resource occupied by a transmission of the sixth channel in the time domain and/or the frequency domain; and ninth indication information for indicating a position of the sixth resource, the position of the sixth resource is used for time domain positioning and/or frequency domain positioning.

When the sixth channel indicates the fifth resource, the sixth channel may indicate at least one of the four contents of the fifth resource, and the sixth channel may directly indicate the contents to be scheduled based on the eighth indication information, or may indicate the contents to be scheduled by the seventh offset.

The seventh offset includes a seventh time domain offset and/or a seventh frequency domain offset, and the seventh time domain offset is an offset of the fifth time domain position with respect to the sixth time domain position, that is, an offset of the fifth resource with respect to the sixth resource in the time domain. The seventh frequency domain offset is an offset of the fifth frequency domain position with respect to the sixth frequency domain position, that is, an offset of the fifth resource with respect to the sixth resource in the frequency domain. The sixth time domain position is a position of the sixth resource in the time domain, and the sixth frequency domain position is a position of the sixth resource in the frequency domain.

In an embodiment of the present disclosure, when the terminal device receives the sixth channel, the terminal device may perform frequency domain positioning and/or time domain positioning based on any one of the first channel and the sixth channel. In the embodiment of the present disclosure, when the terminal device does not receive the sixth channel, the terminal device may perform time domain positioning based on any one of the first channel and the fourth channel, and perform frequency domain positioning based on the first channel.

In some embodiments, a sixth resource occupied by transmission of the sixth channel is determined based on at least one of: factor 6A, the first resource, and an eighth offset which is an offset of the sixth resource in the time domain and/or frequency domain relative to the first resource; factor 6B, the third resource and a ninth offset which is an offset of the sixth resource in the time domain and/or frequency domain relative to the third resource; Factor 6C, tenth indication information for indicating a position and/or size of the sixth resource in the time domain and/or the frequency domain.

For factor 6A, if the eighth offset is an offset of the sixth resource with respect to the first resource in the time domain, the eighth offset is an eighth time domain offset. If the eighth offset is an offset of the sixth resource relative to the first resource in the frequency domain, the eighth offset is an eighth frequency domain offset. If the eighth offset is an offset of the sixth resource in the time domain and the frequency domain relative to the first resource, the eighth offset includes an eighth time domain offset and an eighth frequency domain offset. The sixth time domain position is obtained by shifting the first time domain position by the eighth time domain offset, and the sixth frequency domain position is obtained by shifting the first frequency domain position by the eighth frequency domain offset. The sixth time domain position is a position of the sixth resource in the time domain, and the sixth frequency domain position is a position of the sixth resource in the frequency domain.

For factor 6B, if the ninth offset is the offset of the sixth resource with respect to the third resource in the time domain, the ninth offset is the ninth time domain offset. If the ninth offset is an offset of the sixth resource with respect to the third resource in the frequency domain, the ninth offset is a ninth frequency domain offset. If the ninth offset is an offset of the sixth resource in the time domain and the frequency domain with respect to the third resource, the ninth offset includes a ninth time domain offset and a ninth frequency domain offset. The sixth time domain position is obtained by shifting the third time domain position by the ninth time domain offset, and the sixth frequency domain position is obtained by shifting the third frequency domain position by the ninth frequency domain offset.

In the embodiment of the present disclosure, the sixth resource is determined by determining the following four contents: a sixth time domain position which is a position of the sixth resource in the time domain; a sixth frequency domain position which is a position of the sixth resource in the frequency domain; a sixth time domain size which is a size of the sixth resource in the time domain; and a sixth frequency domain size which is a size of the sixth resource in the frequency domain.

The above four contents of the sixth resource may be determined based on one or more of the factors 6A, 6B, and 6C when the factors 6A, 6B, and 6C do not conflict.

In an example, the sixth time domain position, the sixth frequency domain position, the sixth time domain size, and the sixth frequency domain size are indicated by tenth indication information.

In an example, the sixth time domain position is determined based on the first time domain position and the eighth time domain offset, the sixth frequency domain position is determined based on the third frequency domain position and the ninth frequency domain offset, and the sixth time domain size and the sixth frequency domain size are indicated by the seventh indication information.

In some embodiments, at least one of the following is agreed by a protocol or indicated by the first channel: the eighth offset; the ninth offset; and the tenth indication information.

In an embodiment of the present disclosure, the target AP set is established by interaction on the first channel, the third channel and the fourth channel between the terminal device and the first AP set.

The embodiments of the present disclosure may be implemented as at least one of the following.

The terminal device receives a first channel transmitted by the first AP set, and in case of determining that the first AP set is a target AP set based on the first channel transmitted by the first AP set, transmits a third channel to the first AP set. The terminal device determines a fourth resource, and receives a fourth channel transmitted by the first AP set on the fourth resource. After receiving the fourth channel, the terminal device executes a random access procedure to access the first AP set based on the first random access procedure configuration information corresponding to the first AP set carried by the fourth channel, to be associated with the first AP set as the target AP set, so that the APs in the first AP set jointly provide services to the terminal device.

The manner in which the terminal device determines the fourth resource includes, but is not limited to, the following manner 1, manner 2 and manner 3.

In manner 1, a fourth resource is determined based on a second offset or a third offset carried by the first channel.

In manner 2, a fifth resource is determined based on a fifth offset or a sixth offset carried by the first channel, and the terminal device schedules a fourth resource on the fifth channel received on the fifth resource.

In manner 3, a sixth resource is determined based on an eighth offset or a ninth offset carried by the first channel, the sixth channel received by the terminal device on the sixth resource indicates the fifth resource, and the fifth channel received by the terminal device on the fifth resource schedules the fourth resource.

According to an embodiment of the present disclosure, if the terminal device determines that the first AP set is the target AP set, the terminal device performs the following processing.

In some embodiments, the terminal device transmits or receives a seventh channel, and the seventh channel is used to update an AP included in the target AP set.

In this case, the first AP receives or transmits the seventh channel, and the seventh channel is used to update an AP included in the target AP set.

The seventh channel may be regarded as a channel through which the terminal device performs channel measurement on the first AP or the first AP performs channel measurement on the terminal device.

Here, the AP in the target AP set currently associated with the terminal device is updated, so that the AP included in the target AP set changes. Here, when the target AP set is updated, an AP level is updated. In an example, the target AP set includes AP1, AP2, AP3, and AP4, and the updated target AP set may include Case 1: AP1, AP2, AP3, AP4, AP5; Case 2: AP1, AP2, AP3; Case 3: AP1, AP3, AP6; and Case 4: AP5, AP6, AP7.

When an AP set is a target AP set associated with the terminal device, the AP included in the target AP set may change for the terminal device, but the AP included in the first AP set remains unchanged for the configuration of the AP set.

In some embodiments, an AP included in the target AP set is updated by following operation.

The terminal device measures an AP in a candidate AP set or an AP in a candidate AP set measures the terminal device, and updates the target AP set based on a measurement result. The candidate AP set includes an AP in the first AP set.

It can be understood that the measurement result corresponding to the candidate AP in the candidate AP set is used to update the target AP set, and the candidate AP set includes the AP in the first AP set.

Each of the candidate APs in the candidate AP set needs to receive or transmit the seventh channel.

The measurement result corresponding to the candidate AP in the candidate AP set is a measurement result obtained by measuring the candidate AP in the candidate AP set through the terminal device or a measurement result obtained by measuring the terminal device through the candidate AP.

Here, the CPU may determine a candidate AP set based on the first AP set, the candidate AP set includes an AP of the first AP set, and the terminal device may measure the candidate AP in the candidate AP set, or the candidate AP may measure the terminal device to obtain a measurement result corresponding to the candidate AP. For a candidate AP, whether the candidate AP is an AP in the target AP set is determined based on the measurement result corresponding to the candidate AP.

In an example, the first AP set includes: AP1, AP2, AP3, and AP4, and the candidate AP set may include: AP1, AP2, AP3, AP4, AP5, AP6, AP7, and AP8.

In some embodiments, the measurement result includes at least one of: a reference signal received power RSRP; a signal to interference plus noise ratio SINR.

In some embodiments, for a candidate AP in the candidate AP set, the seventh channel includes at least one of: an uplink measurement channel; and a downlink measurement channel.

For the uplink measurement channel, the terminal device transmits the uplink measurement channel to the candidate AP in the candidate AP set, and the CPU determines an associated AP in the target AP set based on the measurement result of each candidate AP in the candidate AP set.

For the downlink measurement channel, the CPU determines each candidate AP in the candidate AP set, each candidate AP in the candidate AP set transmits the downlink measurement channel to the terminal device, the terminal device measures the received downlink measurement channel to obtain a measurement result, and determines an associated AP in the target AP set based on the measurement result of each candidate AP in the candidate AP set.

In some embodiments, the downlink measurement channel includes one of: the first channel; and the channel state information reference signal CSI-RS.

In an embodiment of the present disclosure, when one candidate AP is an AP set or each AP in the AP set transmits the first channel, the downlink measurement channel includes the first channel.

It is understood that the first channel is for the AP set, and the CSI-RS is for the APs.

In some embodiments, the uplink measurement channel includes one of: a third channel used by the terminal device to establish an association relationship with the target AP set; a sounding reference signal SRS.

In an embodiment of the present disclosure, when one candidate AP is an AP set or a third channel is transmitted to each AP in the AP set, the uplink measurement channel includes the third channel.

It is understood that the third channel is for the AP set, and the SRS is for the APs.

In the embodiment of the present disclosure, the terminal device implements management for the AP set by measuring the first channel and/or the CSI-RS, or measuring the third channel and/or the SRS by the candidate AP in the candidate AP set, to continuously update the AP set associated with the terminal, thereby ensuring that the terminal device is always served by one or more APs with good channel conditions, and ensuring the service quality of the communication system.

Hereinafter, the wireless communication method provided by the embodiment of the present disclosure is further described.

The wireless communication method provided by the embodiment of the present disclosure includes, but is not limited to, the following embodiment 1 and embodiment 2.

In embodiment 1, a AP set associated with the terminal is established

Before the RRC connection is established, the terminal may establish an association relationship with an AP set composed of one or more APs in the network through a random access procedure. The specific process is described as follows.

1) The terminal measures the first channel periodically transmitted by the AP set and determines the target AP set.

The first channel transmitted by the AP set should carry at least the functions of downlink time synchronization, frequency synchronization and AP signal strength measurement, and thus the first channel should contain at least the synchronization signal to implement the functions. The synchronization signal can be transmitted using a pseudo-random sequence, for example, an m-sequence or a Gold sequence having good autocorrelation and cross-correlation characteristics. Based on this, when the terminal detects the synchronization signal, the terminal device may detect the sequence that may be used by the synchronization signal, and when the synchronization signal is detected, the terminal device may implement downlink time-frequency synchronization of the target AP set.

Optionally, the synchronization signals of different AP sets use different sequences, so that the terminal can distinguish different AP sets in the network according to the synchronization signals.

In one example, as illustrated in FIG. 11, AP set 1 and AP set 2 are connected to the CPU, synchronization signal 1 of AP set 1 and synchronization signal 2 of AP set 2 use sequence 1 and sequence 2, respectively. When the terminal device detects the synchronization signal, the terminal device detects using pseudo-random sequences corresponding to sequence 1 and sequence 2, respectively, so as to distinguish the synchronization signals of AP set 1 and AP set 2. Since the distance between the terminal device and AP set 1 is close, the received power of synchronization signal 1 is relatively large, and the terminal device uses AP set 1 as the target AP set to perform downlink time-frequency synchronization.

In some embodiments, the first channel indicates first channel information which includes at least one of: a position of a time domain resource corresponding to the first channel, for example, a radio frame index, a slot index, and a symbol index corresponding to transmission of the first channel, so that the terminal implements radio frame timing, slot timing, and symbol timing after receiving the first channel; a position of the frequency domain resource corresponding to the first channel, for example, an RB index and a subcarrier index corresponding in the initial downlink BWP of transmission of the first channel, so that the terminal determines a frequency domain position relationship between the first channel and the initial downlink BWP after receiving the first channel; and a position and a size of a time domain resource, and a position and a size of a frequency domain resource of transmission of a wireless channel subsequent to the first channel.

2) The terminal device sends a third channel to the target AP set, and requests to establish an association relationship with the target AP set.

The third channel transmitted by the terminal device should carry at least the functions of uplink time synchronization and requesting to establish an association relationship with the target AP set. Therefore, the third channel may be transmitted using a pseudo-random sequence (second pseudo-random sequence), for example, a ZC sequence having a low peak-to-average ratio characteristic. After the AP set transmits the first channel, the AP set detects the third channel at the third time domain position and the third frequency domain position, for example, the AP set detects a sequence that may be used by the third channel, and when the third channel is detected, the AP set may implement uplink time synchronization with the terminal which transmits the third channel. Then, the terminal and the target AP set establish an association relationship through a random access procedure.

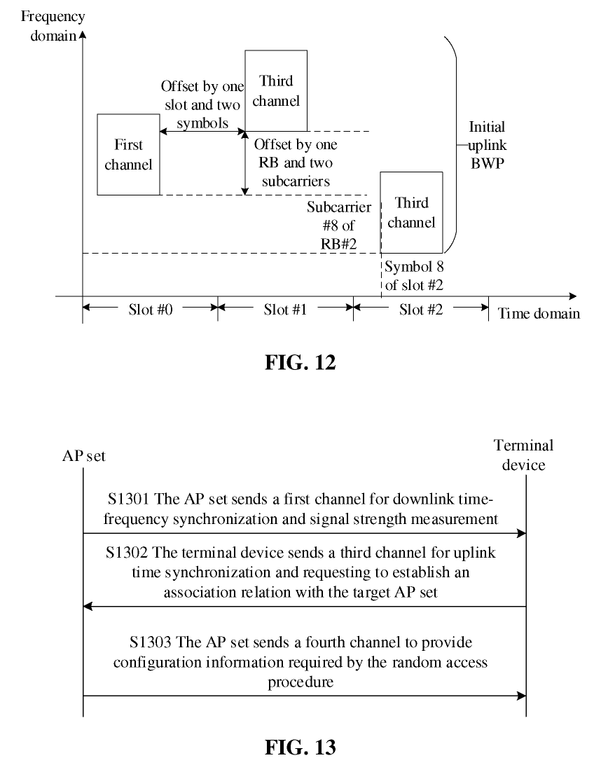

The third time domain position may be determined by a first time domain offset, and the first time domain offset is the number of time domain units by which the third channel is offset relative to the first channel, such as the number of offset slots and symbols. For example, the third time domain position is a time domain position obtained by offsetting by one time slot and two symbols behind the first channel, such as the third channel transmitted in slot # 1 in FIG. 12. The third time domain position may be a designated time domain unit index, such as a designated slot and symbol index, for example, the third time domain position may be a time domain position corresponding to symbol # 8 of slot # 2, such as the third channel transmitted by slot # 2 in FIG. 12. The number of time domain units of the offset included in the first time domain offset and/or the designated time domain unit index may be a default value provided by a protocol or may be provided through the first channel.

The third frequency domain position may be determined based on a first frequency domain offset, and the first frequency domain offset is the number of frequency domain units by which the third channel is offset with respect to the first channel, such as the number of offset RBs and subcarriers. The third frequency domain position is, for example, a frequency domain position obtained by offsetting the first channel by 1 RB and 2 subcarriers, such as the third channel transmitted in slot # 1 in FIG. 12. The first frequency domain position may also be a frequency domain unit index specified in the initial uplink BWP, such as a specified RB and subcarrier index. The first frequency domain position is, for example, a frequency domain position corresponding to subcarrier # 8 of RB # 2, such as a third channel transmitted by slot # 2 in FIG. 12. The number of offset RBs and subcarriers indicated by the first frequency domain offset and/or the designated RB and subcarrier index may be default values provided by the protocol or may be provided through the first channel.

In some embodiments, the size of time domain resources and the size of frequency domain resources occupied by the transmission of the third channel are provided by the first channel. For example, if the number of symbols and the number of RBs occupied by the transmission of the third channel are not fixed, the number of symbols and the number of RBs occupied by the transmission of the third channel may be indicated by the first channel, to ensure that the terminal device and the target AP set have the same understanding for the time-frequency domain resources occupied by the transmission of the third channel.

3) The target AP set sends a fourth channel to the terminal to provide configuration information (that is, first random access resource configuration information) required for the random access procedure.

In response to the transmission of the third channel, the terminal device receives a fourth channel, such as a PDSCH, transmitted by the target AP set at a fourth time domain position and a fourth frequency domain position. The fourth channel carries second information, and the second information includes at least one of: a frequency domain position and bandwidth information of an initial downlink BWP which is a frequency range in which downlink channel transmission is located in the random access process; a frequency domain position and bandwidth information of an initial uplink BWP which is a frequency range in which uplink channel transmission is located in the random access process; time domain position information corresponding to the fourth channel, for example, the fourth channel transmits a radio frame index, a slot index, and a symbol index, so that the terminal device implements radio frame timing, slot timing, and symbol timing after receiving the fourth channel; an RAR message for a terminal, e.g. an RAR message for a terminal which transmits the third channel.

In some embodiments, the RAR message includes timing advance (TA) for the terminal, i.e. a second TA, uplink grant scheduling information, and a temporary identifier used by a random access procedure.

After receiving the fourth channel transmitted by the target AP set, the terminal device can acquire configuration information required for the random access procedure, implement the random access procedure with the target AP set, and establishes an association relationship with the target AP set. As shown in FIG. 13, operations S1301 to S1303 are included.

At S1301, the AP set transmits a first channel for downlink time-frequency synchronization and signal strength measurement.

At S1302, the terminal device transmits a third channel for uplink time synchronization and requests to establish an association relationship with the target AP set.

At S1303, the AP set transmits a fourth channel to provide configuration information required for the random access procedure.

The configuration information required for the random access procedure is the first random access procedure configuration information, and the random access procedure is implemented by the first random access procedure configuration information, thereby establishing an association relationship between the AP set and the terminal device.

In order to determine the fourth time domain position and the fourth frequency domain position, the terminal device needs to listen for a fifth channel, such as a PDCCH, at the fifth time domain position and the fifth frequency domain position before receiving the fourth channel. The fifth channel is used to schedule the fourth channel, and thus carries at least one of the fourth time domain position, the fourth frequency domain position, the size of the time domain resource occupied by the transmission of the fourth channel, and the size of the frequency domain resource occupied by the transmission of the fourth channel.

Based on this, the fourth time domain position may be determined based on a fifth time domain offset, and the fifth time domain offset may be the number of offset time domain units of the fourth channel with respect to the fifth channel, such as the number of offset time slots and symbols. The fourth time domain position may also be a specified time domain unit index, such as a specified slot and symbol index. Similarly, the fourth frequency domain position may be determined based on a fifth frequency domain offset, and the fifth frequency domain offset may be the number of offset frequency domain units of the fourth channel relative to the fifth channel, such as the number of offset RBs and subcarriers. The fourth frequency domain position may also be a frequency domain unit index (such as a specified RB and subcarrier index) specified in the initial downlink BWP.

In order to determine the fifth time domain position and the fifth frequency domain position, the terminal receives a sixth channel, such as a PBCH, at the sixth time domain position and the sixth frequency domain position after transmitting the third channel and before listening to the fifth channel. The sixth channel is used to determine time-frequency domain resources and position information of the fifth channel, and thus the sixth channel carries at least one of the fifth time domain position, the fifth frequency domain position, the size of the time domain resources occupied by the transmission of the fifth channel, the size of the frequency domain resources occupied by the transmission of the fifth channel, and a position of the time domain resource corresponding to the sixth channel. If the sixth channel carries position information of the time domain resource, for example, the sixth channel transmits the radio frame index, the slot index, and the symbol index, the terminal device can implement radio frame timing, slot timing, and symbol timing after receiving the sixth channel.

Based on this, the fifth time domain position may be determined based on a seventh time domain offset, and the seventh time domain offset may be the number of time domain units by which the fifth channel is offset with respect to the sixth channel, such as the number of offset time slots and symbols; The fifth time domain position may also be a specified time domain unit index, such as a specified slot and symbol index. Similarly, the fifth frequency domain position may be determined based on a seventh frequency domain offset, which is the number of frequency domain units by which the fifth channel is offset with respect to the sixth channel, such as the number of offset RBs and subcarriers. The fifth frequency domain position may also be a frequency domain unit index specified in the initial downlink BWP, such as a specified RB and subcarrier index.

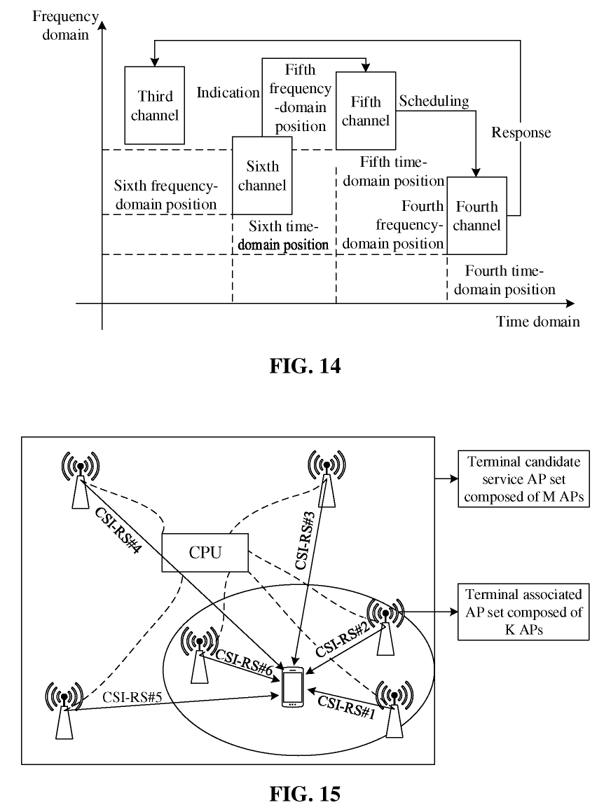

Similarly, the sixth time domain position may be determined based on an eighth time domain offset or a ninth time domain offset, and the eighth time domain offset or the ninth time domain offset is the number of time domain units by which the sixth channel is offset relative to the first channel or the third channel, such as the number of offset slots and symbols. The sixth time domain position may also be a specified time domain unit index, such as a specified slot and symbol index. Similarly, the sixth frequency domain position may be determined based on an eighth frequency domain offset or a ninth frequency domain offset, and the eighth frequency domain offset or the ninth frequency domain offset is the number of frequency domain units by which the sixth channel is offset with respect to the first channel or the third channel, such as the number of offset RBs and subcarriers; The sixth frequency domain position may also be a frequency domain unit index specified in the initial downlink BWP, such as a specified RB and subcarrier index. The sixth time domain position, the sixth frequency domain position, and the size of the time domain resource and the size of the frequency domain resource corresponding to the transmission of the sixth channel are provided through the first channel, as shown in FIG. 14.

In addition, the transmission delay of the NTN system is usually several milliseconds to several hundred milliseconds, and in order to compensate for the influence of the transmission delay on the timing relationship, the terminal needs to adjust the TA before the uplink channel transmission, and the TA, that is, the first TA, in the NTN system is acquired based on at least one of satellite ephemeris information and common TA information.

The information for acquiring the TA in the NTN system may be provided through the first channel, and the terminal can acquire the TA after receiving the first channel, and transmit the third channel to the target AP set after the TA is adjusted, to complete the subsequent random access procedure.

The information for acquiring the TA in the NTN system may also be provided through the fourth channel. In some embodiments, before transmitting the third channel, the terminal receives the fourth channel at the second time domain position, and when the fourth channel transmitted by the AP set is received and the TA information provided by the fourth channel is acquired, the terminal may transmit the third channel to the target AP set after adjusting the TA, to implement the subsequent random access procedure. In another embodiment, the terminal transmits the third channel to the target AP set without adjusting the TA, and in this case, the AP set needs to detect the third channel at the first time domain position after considering the influence of the transmission delay, and provide TA information in the fourth channel, and the terminal may adjust the TA on the uplink transmission after the fourth channel to implement the subsequent random access procedure.

In Embodiment 2, an AP set (that is, a target AP set) associated with a terminal device is updated.

After the terminal device establishes an association relationship with an AP set composed of one or more APs through the random access procedure, the AP set associated with the terminal device should be managed in consideration of the mobility of the AP and the terminal device, for example, the AP set associated with the terminal is continuously updated, so as to ensure that the terminal device is always served by one or more APs with a good channel condition.

The AP set may be managed by measuring the first channel and/or the CSI-RS, and the measurement result RSRP and/or SINR may be used as a metric. For example, the CPU regards M APs in the network as a set of candidate serving APs of the terminal, and allocates an independent first channel resource and/or CSI-RS resource to the AP in the set for association. The terminal reports third information to the network according to the result of measuring the first channel and/or the CSI-RS, and the third information includes K≥1 pieces of first channel resource indication information and/or CSI-RS resource indication information and corresponding measurement results RSRP and/or SINR.

In this case, the CPU determines an AP set associated with the terminal according to the third information reported by the terminal and the association relationship between the AP and the first channel resource and/or the CSI-RS resource. As shown in FIG. 15, M APs constitute a candidate service AP set of the terminal, that is, a candidate AP set, K APs constitute an AP set associated with the terminal, that is, a target AP set, and M APs in the candidate AP set include K APs in the target AP set.

The AP set may also be managed by measuring the third channel and/or SRS, and the measurement result RSRP and/or SINR may be used as a metric. For example, the CPU takes M APs in the network as a candidate serving AP set of the terminal, receives the third channel and/or SRS sent by the terminal, and determines the AP set associated with the terminal based on the measurement results RSRP and/or SINR of the M APs.

It should be noted that, in the NTN system, the transmission delays between different APs and the terminal are greatly different, and therefore, the terminal needs to consider the transmission delays of different APs when measuring first channel and/or CSI-RS. In a possible implementation, the AP indicates the association relationship of the first channel resource and/or the CSI-RS resource with the ephemeris information to the terminal. When the terminal measures the first channel and/or the CSI-RS, the terminal calculates the transmission delay according to the ephemeris information associated with the first channel resource and/or the CSI-RS resource, and measures the first channel and/or the CSI-RS at the time domain position after considering the influence of the transmission delay.

For example, AP#1 and AP#2 in the candidate service AP set are associated with CSI-RS resource #1 and CSI-RS resource #2, respectively, and the terminal is notified of ephemeris information of AP#1 and AP#2. When measuring the CSI-RS, the terminal calculates transmission delays T1 and T2 according to the ephemeris information of AP#1 and AP#2, respectively, and measures CSI-RS#2 after additionally delaying a time length of T2-T1 relative to a time when CSI-RS#1 is measured.

The preferred embodiments of the present disclosure have been described in detail above with reference to the accompanying drawings, but the present disclosure is not limited to the specific details in the above-described embodiments. Within the scope of the technical concept of the present disclosure, various simple modifications can be made to the technical solutions of the present disclosure, and these simple modifications all fall within the scope of protection of the present disclosure. For example, various specific technical features described in the above-described embodiments can be combined in any suitable manner without contradiction, and various possible combinations will not be described separately in this disclosure in order to avoid unnecessary repetition. For example, various embodiments of the present disclosure may be combined arbitrarily, and as long as the combinations do not violate the idea of the present disclosure, they should also be regarded as the disclosure of the present disclosure. For another example, on the premise that there is no conflict, variou embodiments described in the present disclosure and/or the technical features in each embodiment can be arbitrarily combined with the prior art, and the technical solution obtained after the combination should also fall within the scope of protection of the present disclosure.

It should also be understood that in various method embodiments of the present disclosure, the size of the sequence number of the above-described processes does not mean the sequence of execution, and the sequence of execution of each process should be determined by the function and internal logic thereof, and should not constitute any limitation on the implementation of the embodiments of the present disclosure. In addition, in the embodiment of the present disclosure, the terms "downlink", "uplink", and "sidelink" are used to indicate the transmission direction of signals or data, the "downlink" is used to indicate that the transmission direction of signals or data is a first direction transmitted from the station to the user equipment of the cell, the "uplink" is used to indicate that the transmission direction of signals or data is a second direction transmitted from the user equipment of the cell to the station, and the "sidelink" is used to indicate that the transmission direction of signals or data is a third direction transmitted from the user equipment 1 to the user equipment 2. For example, the "downlink signal" indicates that the transmission direction of the signal is the first direction. In addition, in the embodiment of the present disclosure, the term "and/or" only indicates an association relationship for describing association objects, and indicates that there may be three relationships. Specifically, A and/or B may represent three cases of A alone, A and B simultaneously, and B alone. In addition, the character "/" herein generally indicates that the front and back objects are in an "or" relationship.

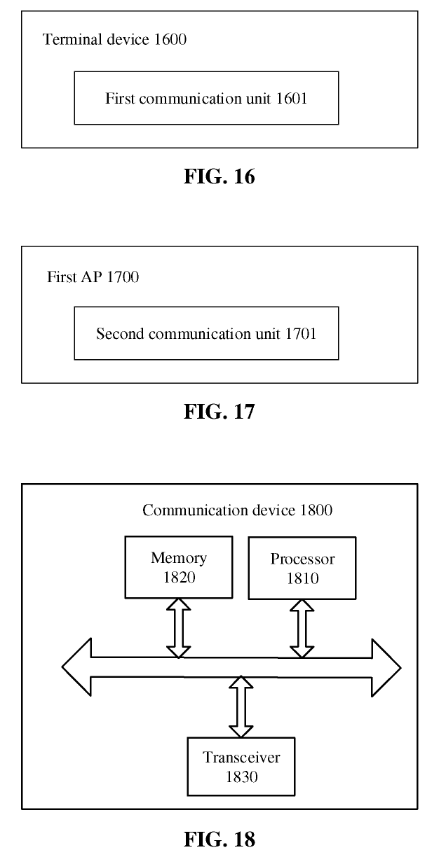

FIG. 16 is a schematic structural composition diagram of a wireless communication terminal device according to an embodiment of the present disclosure. As shown in FIG. 16, the terminal device includes a first communication unit 1601.

The first communication unit 1601 is configured to receive at least one first channel transmitted by a first access device set. The first access device set includes at least one access device, the at least one first channel transmitted by the first access device set is used to determine whether the first access device set is a target access device set, and the target access device set is used to perform data communication with the terminal device.

In some embodiments, a first received power is used to determine whether the first access device set is the target access device set, and the first received power is determined based on a received power of the first channel which is transmitted by the first access device set and received by the terminal device.

In some embodiments, the first channel carries a downlink synchronization signal, and the downlink synchronization signal is used by the terminal device to perform downlink synchronization with the access device set which transmits the first channel.

In some embodiments, downlink synchronization signals in the first channels transmitted by different access device sets are transmitted using different first pseudo-random sequences.

In some embodiments, the first channel carries at least one of: first indication information indicating a position of a first resource, the first resource is a resource occupied by transmission of the first channel, and the position of the first resource is used for time domain positioning and/or frequency domain positioning; second indication information indicating a second resource, the second resource is a resource occupied by transmission of a second channel, and the second channel is a wireless channel after the first channel; and first information used by the terminal device to determine a first timing advance TA.

In some embodiments, the first communication unit 1601 is further configured to transmit a third channel to the first access device set if it is determined that the first access device set is the target access device set. The third channel is used by the terminal device to establish an association relationship with the first access device set.

In some embodiments, the third channel carries an uplink synchronization signal, and the uplink synchronization signal is used by the terminal device to perform uplink synchronization with the target access device set.

In some embodiments, the third resource occupied by the transmission of the third channel is determined based on at least one of: a first resource that is a resource occupied by transmission of the first channel, and a first offset that is an offset of the third resource relative to the first resource in the time domain and/or the frequency domain; and third indication information for indicating a position and/or a size of the third resource in the frequency domain and/or the time domain.

In some embodiments, at least one of the following is agreed by a protocol or indicated by the first channel: the first offset; and the third indication information.

In some embodiments, the first communication unit 1601 is further configured to receive a fourth channel transmitted by the first access device set. The fourth channel is used to carry first random access configuration information corresponding to the first access device set, and the first random access configuration information is used for a random access procedure in which the terminal device accesses the first access device set.

In some embodiments, the first random access configuration information includes at least one of: a first frequency range which is a frequency range in which downlink channel transmission in the random access procedure is located; and a second frequency range which is a frequency range in which the uplink channel transmission in the random access procedure is located.

In some embodiments, the fourth channel is further configured to carry at least one of: fourth indication information for indicating a time domain position of a fourth resource, the fourth resource is a resource occupied by transmission of the fourth channel, and the time domain position of the fourth resource is used for time domain positioning; first information used by the terminal device to determine a first TA; and a random Access Response (RAR) message.

In some embodiments, the first TA is used to adjust a transmission time of a first uplink transmission, and the first uplink transmission is an uplink transmission after receiving the first information.

In some embodiments, reception of the fourth channel precedes transmission of a third channel, the third channel is a channel transmitted by the terminal device to the first AP set in case that it is determined that the first AP set is the target AP set, and the third channel is used by the terminal device to establish an association relationship with the target AP set.

Alternatively, transmission of the third channel precedes reception of the fourth channel.

In some embodiments, a fourth resource occupied by transmission of the fourth channel is determined based on at least one of: a first resource that is a resource occupied by transmission of the first channel, and a second offset that is an offset of the fourth resource relative to the first resource in the time domain and/or the frequency domain; and a third resource which is a resource occupied by a transmission of a third channel preceding the fourth channel, and a third offset which is an offset of the fourth resource relative to the third resource in the time domain and/or the frequency domain; fifth indication information for indicating a position and/or size of the fourth resource in the frequency domain and/or the time domain; and a fifth channel for scheduling the fourth channel.

In some embodiments, at least one of the following is agreed by a protocol or indicated by the first channel: the second offset; the third offset; and the fifth indication information.

In some embodiments, the fifth channel includes at least one of: sixth indication information for indicating a position and/or a size of the fourth resource in the frequency domain and/or the time domain; a fourth offset which is an offset of the fourth resource relative to a fifth resource occupied by a transmission of the fifth channel in the time domain and/or the frequency domain.

In some embodiments, a fifth resource occupied by transmission of the fifth channel is determined based on at least one of: the first resource and a fifth offset which is an offset of the fifth resource relative to the first resource in the time domain and/or the frequency domain; the third resource and a sixth offset which is an offset of the fifth resource relative to the third resource in the time domain and/or the frequency domain; seventh indication information for indicating a position and/or size of the fifth resource in the time domain and/or the frequency domain; and a sixth channel for indicating a position and/or size of the fifth resource in the time domain and/or the frequency domain.

In some embodiments, at least one of the following is agreed by a protocol or indicated by the first channel: the fifth offset; the sixth offset; and the seventh indication information.

In some embodiments, the sixth channel includes at least one of: eighth indication information for indicating a position and/or a size of the fifth resource in the time domain and/or the frequency domain; a seventh offset which is an offset of the fifth resource relative to a sixth resource occupied by a transmission of the sixth channel in the time domain and/or the frequency domain; and ninth indication information for indicating a position of the sixth resource, the position of the sixth resource is used for time domain positioning and/or frequency domain positioning.

In some embodiments, a sixth resource occupied by transmission of the sixth channel is determined based on at least one of: the first resource and an eighth offset which is an offset of the sixth resource in the time domain and/or frequency domain relative to the first resource; the third resource and a ninth offset which is an offset of the sixth resource in the time domain and/or frequency domain relative to the third resource; tenth indication information for indicating a position and/or size of the sixth resource in the time domain and/or the frequency domain.

In some embodiments, at least one of the following is agreed by a protocol or indicated by the first channel: the eighth offset; the ninth offset; and the tenth indication information.

In some embodiments, the first communication unit 1601 is further configured to transmit or receive a seventh channel when it is determined that the first access device set is the target access device set, and the seventh channel is used for updating access devices included in the target access device set.

In some embodiments, a measurement result corresponding to an access device in a candidate access device set is used to update the target access device set, and the candidate access device set includes the access device in the first access device set.

In some embodiments, the measurement result includes at least one of: a reference signal received power RSRP; a signal to interference plus noise ratio SINR.

In some embodiments, for the candidate access device in the candidate access device set, the seventh channel comprises at least one of: an uplink measurement channel; and a downlink measurement channel.

In some embodiments, the downlink measurement channel includes one of: the first channel; and a channel state information reference signal.

In some embodiments, the uplink measurement channel includes one of: a third channel used by the terminal device to establish an association relationship with the target access device set; and a sounding reference signal.

FIG. 17 is a schematic structural composition diagram of a first access device according to an embodiment of the present disclosure, and as shown in FIG. 17, the first access device includes a second communication unit 1701.

The second communication unit 1701 is configured to transmit, to a terminal device, a first channel. The first access device belongs to a first access device set, and the first access device set includes at least one access device, at least one of first channels transmitted by the first access device set is used for determining whether the first access device set is a target access device set, and the target access device set is used for data communication with the terminal device.

In some embodiments, a first received power is used to determine whether the first access device set is the target access device set, and the first received power is determined based on a received power of the first channel which is transmitted by the first access device set and received by the terminal device.

In some embodiments, the first channel carries a downlink synchronization signal, and the downlink synchronization signal is used by the terminal device to perform downlink synchronization with the access device set which transmits the first channel.

In some embodiments, downlink synchronization signals in the first channels transmitted by different access device sets are transmitted using different first pseudo-random sequences.

In some embodiments, the first channel carries at least one of: first indication information indicating a position of a first resource, the first resource is a resource occupied by transmission of the first channel, and the position of the first resource is used for time domain positioning and/or frequency domain positioning; second indication information indicating a second resource, the second resource is a resource occupied by transmission of a second channel, and the second channel is a wireless channel after the first channel; and first information used by the terminal device to determine a first timing advance TA.

In some embodiments, the second communication unit 1701 is further configured to receive a third channel sent by the terminal device if it is determined that the first access device set is the target access device set. The third channel is used by the terminal device to establish an association relationship with the first access device set.

In some embodiments, the third channel carries an uplink synchronization signal, and the uplink synchronization signal is used by the terminal device to perform uplink synchronization with the target access device set.

In some embodiments, the third resource occupied by the transmission of the third channel is determined based on at least one of: a first resource that is a resource occupied by transmission of the first channel, and a first offset that is an offset of the third resource relative to the first resource in the time domain and/or the frequency domain; and third indication information for indicating a position and/or a size of the third resource in the frequency domain and/or the time domain.

In some embodiments, at least one of the following is agreed by a protocol or indicated by the first channel: the first offset; and the third indication information.

In some embodiments, the second communication unit 1701 is further configured to transmit a fourth channel to the terminal device. The fourth channel is used to carry first random access configuration information corresponding to the first access device set, and the first random access configuration information is used for a random access procedure in which the terminal device accesses the first access device set.

In some embodiments, the first random access configuration information includes at least one of: a first frequency range which is a frequency range in which downlink channel transmission in the random access procedure is located; and a second frequency range which is a frequency range in which the uplink channel transmission in the random access procedure is located.

In some embodiments, the fourth channel is further used to carry at least one of: fourth indication information for indicating a time domain position of a fourth resource, the fourth resource is a resource occupied by transmission of the fourth channel, and the time domain position of the fourth resource is used for time domain positioning; first information used by the terminal device to determine a first TA; and a random Access Response (RAR) message.

In some embodiments, the first TA is used to adjust a transmission time of a first uplink transmission, and the first uplink transmission is an uplink transmission after receiving the first information.

In some embodiments, reception of the fourth channel precedes transmission of a third channel, the third channel is a channel transmitted by the terminal device to the first AP set in case that it is determined that the first AP set is the target AP set, and the third channel is used by the terminal device to establish an association relationship with the target access device set.

Alternatively, transmission of the third channel precedes reception of the fourth channel.

In some embodiments, a fourth resource occupied by transmission of the fourth channel is determined based on at least one of: a first resource that is a resource occupied by transmission of the first channel, and a second offset that is an offset of the fourth resource relative to the first resource in the time domain and/or the frequency domain; and a third resource which is a resource occupied by a transmission of a third channel preceding the fourth channel, and a third offset which is an offset of the fourth resource relative to the third resource in the time domain and/or the frequency domain; fifth indication information for indicating a position and/or size of the fourth resource in the frequency domain and/or the time domain; and a fifth channel for scheduling the fourth channel.

In some embodiments, at least one of the following is agreed by a protocol or indicated by the first channel: the second offset; the third offset; and the fifth indication information. In some embodiments, the fifth channel includes at least one of: sixth indication information for indicating a position and/or a size of the fourth resource in the frequency domain and/or the time domain; a fourth offset which is an offset of the fourth resource relative to a fifth resource occupied by a transmission of the fifth channel in the time domain and/or the frequency domain.

In some embodiments, the fifth resource occupied by transmission of the fifth channel is determined based on at least one of: the first resource and a fifth offset which is an offset of the fifth resource relative to the first resource in the time domain and/or the frequency domain; the third resource and a sixth offset which is an offset of the fifth resource relative to the third resource in the time domain and/or the frequency domain; seventh indication information for indicating a position and/or size of the fifth resource in the time domain and/or the frequency domain; and a sixth channel for indicating a position and/or size of the fifth resource in the time domain and/or the frequency domain.

In some embodiments, at least one of the following is agreed by a protocol or indicated by the first channel: the fifth offset; the sixth offset; and the seventh indication information.

In some embodiments, the sixth channel includes at least one of: eighth indication information for indicating a position and/or a size of the fifth resource in the time domain and/or the frequency domain; a seventh offset which is an offset of the fifth resource relative to a sixth resource occupied by a transmission of the sixth channel in the time domain and/or the frequency domain; and ninth indication information for indicating a position of the sixth resource, the position of the sixth resource is used for time domain positioning and/or frequency domain positioning.

In some embodiments, a sixth resource occupied by transmission of the sixth channel is determined based on at least one of: the first resource and an eighth offset which is an offset of the sixth resource in the time domain and/or frequency domain relative to the first resource; the third resource and a ninth offset which is an offset of the sixth resource in the time domain and/or frequency domain relative to the third resource; tenth indication information for indicating a position and/or size of the sixth resource in the time domain and/or the frequency domain.

In some embodiments, at least one of the following is agreed by a protocol or indicated by the first channel: the eighth offset; the ninth offset; and the tenth indication information.

In some embodiments, the second communication unit 1701 is further configured to receive or transmit a seventh channel when it is determined that the first access device set is the target access device set, and the seventh channel is used for updating access devices included in the target access device set.

In some embodiments, a measurement result corresponding to an access device in a candidate access device set is used to update the target access device set, and the candidate access device set includes the access device in the first access device set.

In some embodiments, the measurement result includes at least one of: a reference signal received power RSRP; a signal to interference plus noise ratio SINR.

In some embodiments, for the candidate access device in the candidate access device set, the seventh channel comprises at least one of: an uplink measurement channel; and a downlink measurement channel.

In some embodiments, the downlink measurement channel includes one of the following: the first channel; and a channel state information reference signal.

In some embodiments, the uplink measurement channel includes one of: a third channel used by the terminal device to establish an association relationship with the target access device set; and a sounding reference signal.

Those skilled in the art should understand that the related description of the above-described terminal device or the first access device according to the embodiment of the present disclosure can be understood with reference to the related description of the wireless communication method according to the embodiment of the present disclosure.

FIG. 18 is a schematic structural diagram of a communication device 1800 according to an embodiment of the present disclosure. The communication device may be a terminal device or a first access device. The communication device 1800 illustrated in FIG. 18 includes a processor 1810 that can call and run a computer program from a memory to implement the method in the embodiment of the present disclosure.

Optionally, as shown in FIG. 18, the communication device 1800 may further include a memory 1820. The processor 1810 may call and run a computer program from the memory 1820 to implement the method in the embodiment of the present disclosure.

The memory 1820 may be a separate device independent of the processor 1810 or may be integrated in the processor 1810.

Optionally, as shown in FIG. 18, the communication device 1800 may further include a transceiver 1830, and the processor 1810 may control the transceiver 1830 to communicate with other devices, specifically, to transmit information or data to other devices, or receive information or data transmitted by other devices.

The transceiver 1830 may include a transmitter and a receiver. The transceiver 1830 may further include the antennas, and the number of antennas may be one or more.

Optionally, the communication device 1800 may be the first access device according to the embodiment of the present disclosure, and the communication device 1800 may implement corresponding processes implemented by the first access device in each method according to the embodiment of the present disclosure, which will not be described herein for the sake of brevity.

Optionally, the communication device 1800 may be a mobile terminal/terminal device according to the embodiment of the present disclosure, and the communication device 1800 may implement corresponding processes implemented by the mobile terminal/terminal device in each method according to the embodiment of the present disclosure, and will not be described herein for the sake of brevity.

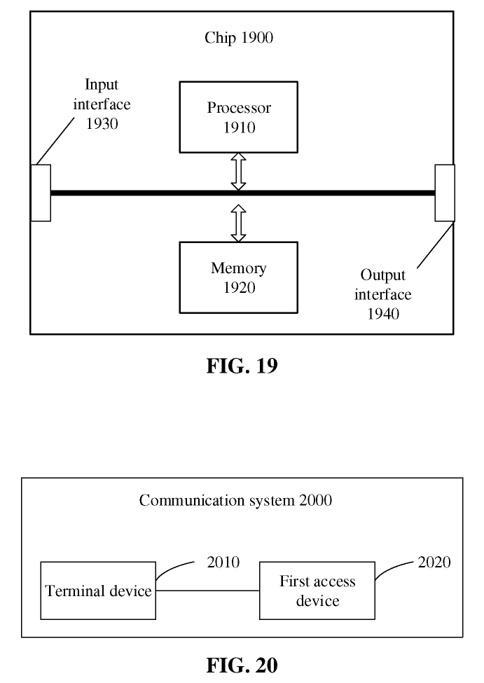

FIG. 19 is a schematic structural diagram of a chip according to an embodiment of the present disclosure. The chip 1900 shown in FIG. 19 includes a processor 1910, which can call and run a computer program from a memory to implement the method in the embodiment of the present disclosure.

Optionally, as shown in FIG. 19, the chip 1900 may further include a memory 1920. The processor 1910 may call and run a computer program from the memory 1920 to implement the method in the embodiment of the present disclosure.

The memory 1920 may be a separate device independent of the processor 1910 or may be integrated in the processor 1910.

Optionally, the chip 1900 may further include an input interface 1930. The processor 1910 may control the input interface 1930 to communicate with other devices or chips, specifically, to acquire information or data transmitted by other devices or chips.

Optionally, the chip 1900 may further include an output interface 1940. The processor 1910 may control the output interface 1940 to communicate with other devices or chips, to output information or data to other devices or chips.

Optionally, the chip can be applied to the first access device in the embodiment of the present disclosure, and the chip can implement the corresponding process implemented by the first access device in each method of the embodiment of the present disclosure, which will not be repeated here for the sake of brevity.

Optionally, the chip can be applied to the mobile terminal/terminal device in the embodiment of the present disclosure, and the chip can implement the corresponding flow implemented by the mobile terminal/terminal device in each method of the embodiment of the present disclosure, which will not be repeated here for the sake of brevity.

It should be understood that the chip mentioned in the embodiments of the present disclosure may also be referred to as a system-level chip, a system level, a chip system or a system-on-chip chip.

FIG. 20 is a schematic block diagram of a communication system 2000 according to an embodiment of the present disclosure. As shown in FIG. 20, the communication system 2000 includes a terminal device 2010 and a first access device 2020.

Here, the terminal device 2010 may be used to implement the corresponding functions implemented by the terminal device in the above-described method, and the first access device 2020 may be used to implement the corresponding functions implemented by the first access device in the above-described method, which will not be described herein for the sake of brevity.

It should be understood that the processor of the embodiment of the present disclosure may be an integrated circuit chip having signal processing capabilities. In the implementation process, the steps of the above-described method embodiments may be implemented by integrated logic circuits of hardware in the processor or instructions in the form of software. The processor described above may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, steps, and logical block diagrams disclosed in the embodiments of the present disclosure may be implemented or executed. The general-purpose processor may be a microprocessor or the processor may be any conventional processor or the like. The steps of the method disclosed in connection with the embodiments of the present disclosure may be directly embodied to be executed by the hardware decoding processor, or may be executed by combining hardware and software modules in the decoding processor. The software module may be located in a storage medium mature in the art, such as a random access memory, a flash memory, a read-only memory, a programmable read-only memory, or an electrically erasable programmable memory, a register, etc. The storage medium is located in the memory, and the processor reads the information in the memory, and completes the steps of the above method in conjunction with the hardware thereof.

It is understood that the memory in the embodiments of the present disclosure may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of illustration, but not by way of limitation, many forms of RAM are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It should be noted that the memory of the systems and methods described herein is intended to include, but is not limited to, these and any other suitable type of memory.

It should be understood that the above memory is illustrative but not restrictive, for example, the memory in the embodiments of the present disclosure may also be a static random access memory (SRAM), a dynamic random access memory (DRAM), a synchronous dynamic random access memory (SDRAM), a double data rate SDRAM (DDR SDRAM), an enhanced SDRAM (ESDRAM), a synch link DRAM (SLDRAM), a Direct Rambus RAM (DR RAM), and the like. That is, the memory in the embodiments of the present disclosure is intended to include, but is not limited to, these and any other suitable type of memory.

The embodiments of the present disclosure also provide a computer-readable storage medium for storing a computer program.

Optionally, the computer-readable storage medium can be applied to the first access device in the embodiment of the present disclosure, and the computer program causes the computer to execute corresponding processes implemented by the first access device in each method in the embodiment of the present disclosure, which will not be described herein for the sake of brevity.

Optionally, the computer-readable storage medium can be applied to the mobile terminal/terminal device in the embodiment of the present disclosure, and the computer program causes the computer to execute the corresponding flow implemented by the mobile terminal/terminal device in each method of the embodiment of the present disclosure, which will not be repeatedly described herein for the sake of brevity.

The embodiments of the present disclosure also provide a computer program product including computer program instructions.

Optionally, the computer program product can be applied to the first access device in the embodiment of the present disclosure, and the computer program instructions cause the computer to execute the corresponding process implemented by the first access device in each method in the embodiment of the present disclosure, which is not repeated here for the sake of brevity.

Optionally, the computer program product can be applied to the mobile terminal/terminal device in the embodiment of the present disclosure, and the computer program instructions cause the computer to execute the corresponding flow implemented by the mobile terminal/terminal device in each method of the embodiment of the present disclosure, which will not be repeated here for the sake of brevity.

The embodiments of the present disclosure further provide a computer program.

Optionally, the computer program may be applied to the first access device in the embodiment of the present disclosure, and when the computer program is run on the computer, the computer program enables the computer to execute the corresponding process implemented by the first access device in each method of the embodiment of the present disclosure, which will not be repeated herein for the sake of brevity.

Optionally, the computer program can be applied to the mobile terminal/terminal device in the embodiment of the present disclosure, and when the computer program is run on the computer, the computer program enables the computer to execute the corresponding flow implemented by the mobile terminal/terminal device in each method of the embodiment of the present disclosure, which is not repeated here for the sake of brevity.

Those of ordinary skill in the art will appreciate that the elements and algorithmic steps of the various examples described in connection with the embodiments disclosed herein can be implemented in electronic hardware, or a combination of computer software and electronic hardware. Whether the functions are performed in hardware or software depends on the specific application and design constraints of the technical solution. Those skilled in the art may use different methods for implementing the described functions of each particular application, but such implementations should not be considered beyond the scope of the present disclosure.

Those skilled in the art can clearly understand that for convenience and conciseness of the description, specific operation processes of the systems, devices, and units described above may not be described repeatedly by referring to the corresponding processes in the aforementioned method embodiments.

In several embodiments provided herein, it should be understood that the disclosed systems, apparatuses, and methods may be implemented in other ways. For example, the device embodiments described above are merely schematic. For example, the division of units is only one logical function division, and there may be other division methods in actual implementation, for example, multiple units or components may be combined or integrated into another system, or some features may be ignored or not implemented. In addition, the shown or discussed coupling or direct coupling or communication connection may be an indirect coupling or communication connection through some interface, device or unit, which may be electrical, mechanical or otherwise.

The units described as separate components may or may not be physically separate, and the components displayed as units may or may not be physical units, that is, the components may be located in one place or may be distributed over multiple network units. Some or all of the units may be selected according to actual needs to achieve the purpose of the solution of the present embodiment.

In addition, all functional units in each embodiment of the present disclosure may be integrated in one processing unit, or each functional unit may be physically present alone, or two or more units may be integrated in one unit.

The functions may be stored in a computer-readable storage medium if implemented in the form of software functional units and sold or used as independent products. Based on this understanding, the technical solution of the present disclosure essentially or a part that contributes to the prior art or a part of the technical solution may be embodied in the form of a software product, and the computer soft product is stored in a storage medium and includes several instructions for causing a computer device (which may be a personal computer, a server, or a network device, etc.) to perform all or part of the steps of the method described in various embodiments of the present disclosure . The storage medium includes a USB disk, a removable hard disk, a Read-Only Memory (ROM), a Random Access Memory (RAM), a magnetic disk, or an optical disk, or a medium which can store a program code.

The foregoing is merely a specific embodiment of the present disclosure, but the scope of protection of the present disclosure is not limited thereto, and the changes or substitution easily conceived by any person skilled in the art within the technical scope disclosed in the present disclosure should be covered within the scope of protection of the present disclosure. Therefore, the scope of protection of the present disclosure should be subject to the scope of protection of the claims.

What is claimed is:

1. A wireless communication method, comprising:
receiving, by a terminal device, at least one first channel transmitted by a first access device set, wherein the first access device set comprises at least one access device, the at least one first channel transmitted by the first access device set is used for determining whether the first access device set is a target access device set, and the target access device set is used for performing data communication with the terminal device.

2. The method of claim 1, wherein a first received power is used to determine whether the first access device set is the target access device set, and the first received power is determined based on a received power of the first channel which is transmitted by the first access device set and received by the terminal device.

3. The method of claim 1, wherein the first channel carries a downlink synchronization signal, and the downlink synchronization signal is used by the terminal device to perform downlink synchronization with the access device set which transmits the first channel.

4. The method of claim 3, wherein downlink synchronization signals in the first channels transmitted by different access device sets are transmitted using different first pseudo-random sequences.

5. The method of claim 1, wherein the first channel carries at least one of:
first indication information for indicating a position of a first resource, wherein the first resource is a resource occupied by transmission of the first channel, and the position of the first resource is used for time domain positioning and/or frequency domain positioning;
second indication information for indicating a second resource, wherein the second resource is a resource occupied by transmission of a second channel, and the second channel is a wireless channel after the first channel; or
first information used by the terminal device to determine a first timing advance TA.

6. The method of claim 1, wherein if it is determined that the first access device set is the target access device set, the method further comprises:
transmitting, by the terminal device, a third channel to the first access device set, wherein the third channel is used by the terminal device to establish an association relationship with the first access device set.

7. The method of claim 6, wherein the third channel carries an uplink synchronization signal, and the uplink synchronization signal is used for uplink synchronization between the terminal device and the target access device set.

8. The method of claim 6, wherein a third resource occupied by a transmission of the third channel is determined based on at least one of:
a first resource and a first offset, wherein the first resource is a resource occupied by transmission of the first channel, and the first offset is an offset of the third resource relative to the first resource in a time domain and/or a frequency domain; or
third indication information for indicating a position and/or a size of the third resource in a frequency domain and/or a time domain.

9. The method of claim 8, wherein at least one of the first offset or the third indication information is agreed by a protocol or indicated by the first channel.

10. The method of claim 1, further comprising:
receiving, by the terminal device, a fourth channel transmitted by the first access device set, wherein the fourth channel is used for carrying first random access configuration information corresponding to the first access device set, and the first random access configuration information is used for a random access procedure in which the terminal device accesses the first access device set.

11. A wireless communication method, comprising:
transmitting, by a first access device, a first channel to a terminal device, wherein the first access device belongs to a first access device set, and the first access device set comprises at least one access device, at least one of the first channel transmitted by the first access device set is used for determining whether the first access device set is a target access device set, and the target access device set is used for performing data communication with the terminal device.

12. The method of claim 11, further comprising:
transmitting, by the first access device, a fourth channel to the terminal device, wherein the fourth channel is used for carrying first random access configuration information corresponding to the first access device set, and the first random access configuration information is used for a random access procedure in which the terminal device accesses the first access device set.

13. The method of claim 12, wherein the first random access configuration information comprises at least one of:
a first frequency range, which is a frequency range in which downlink channel transmission in the random access procedure is located; or
a second frequency range, which is a frequency range in which the uplink channel transmission in the random access procedure is located.

14. The method of claim 12, wherein the fourth channel further carries at least one of:
fourth indication information for indicating a time domain position of a fourth resource, wherein the fourth resource is a resource occupied by transmission of the fourth channel, and the time domain position of the fourth resource is used for time domain positioning;
first information used by the terminal device to determine a first TA; or
a Random Access Response RAR message.

15. The method of claim 14, wherein the first TA is used to adjust a transmission time of a first uplink transmission, and the first uplink transmission is an uplink transmission after receiving the first information.

16. The method of claim 12, wherein,
reception of the fourth channel precedes transmission of a third channel, the third channel is a channel transmitted by the terminal device to the first access device set in case that it is determined that the first access device set is the target access device set, and the third channel is used by the terminal device to establish an association relationship with the target access device set; or,
transmission of the third channel precedes reception of the fourth channel.

17. The method of claim 12, wherein a fourth resource occupied by transmission of the fourth channel is determined based on at least one of:
a first resource and a second offset, wherein the first resource is a resource occupied by transmission of the first channel, and the second offset is an offset of the fourth resource relative to the first resource in a time domain and/or a frequency domain;
a third resource and a third offset, wherein the third resource is a resource occupied by transmission of a third channel before the fourth channel, and the third offset is an offset of the fourth resource relative to the third resource in a time domain and/or a frequency domain;
fifth indication information for indicating a position and/or a size of the fourth resource in a frequency domain and/or a time domain; or
a fifth channel for scheduling the fourth channel.

18. The method of claim 17, wherein at least one of the second offset, the third offset or the fifth indication information is agreed by a protocol or indicated by the first channel.

19. The method of claim 17, wherein the fifth channel comprises at least one of:
sixth indication information for indicating a position and/or a size of the fourth resource in a frequency domain and/or a time domain; or
a fourth offset which is an offset in a time domain and/or a frequency domain of the fourth resource relative to a fifth resource occupied by a transmission of the fifth channel.

20. A communication device comprising a transceiver, a processor and a memory having a computer program stored thereon, wherein the processor is configured for invoking and running the computer program stored in the memory, to control the transceiver to receive at least one first channel transmitted by a first access device set, wherein the first access device set comprises at least one access device, the at least one first channel transmitted by the first access device set is used for determining whether the first access device set is a target access device set, and the target access device set is used for performing data communication with the communication device.
